(19) United States
(12) Patent Application Publication
(10) Pub. No.: US 2002/0138843 A1
(43) Pub. Date: Sep. 26, 2002

(54) Video distribution method and system

(76) Inventors: Andrew Samaan, New York, NY (US); Scott Spector, New York, NY (US)

Correspondence Address: R. NEIL SUDOL, COLEMAN SUDOL SAPONE, P.C., 714 Colorado Avenue, Bridgeport, CT, 06605-1601, US

(21) Appl. No.: 09/861,378

(22) Filed: May 18, 2001

Related U.S. Application Data
(60) Provisional application No. 60/205,488, filed on May 19, 2000.

(51) Int. Cl. G06F 3/00; H04N 5/445; G06F 13/00; H04N 7/173

(52) U.S. Cl. 725/87; 725/93; 725/37; 725/116; 725/61

(57) ABSTRACT

In a video distribution system receiving, at least one video clip is received from each of a plurality of user parties over a computer network and the received video clips are stored at a central location in groups defined by the user parties. Requests received from a plurality of second, recipient parties over the computer network each identify a respective one of the user parties and a video clip uploaded by that one first party for storage at the central location. To each second party is transmitted at least one video clip uploaded to the central location by a respective user party identified in the respective request from that second party. The video distribution system contemplates a filtering process whereby the second parties are permitted only selective access to the entire video collection of any particular user. The video distribution system also provide a procedure for providing video clips to the second parties as components of a combined graphics and video transmission. A user party selects a graphic illustration and a video clip for cotransmission as a video greeting card. In response to a request from a given recipient party, the graphic illustration and the video clip are transmitted over the computer network to that given recipient party so that the selected graphic illustration and the selected video clip appear on the monitor of the recipient in temporal and spatial juxtaposition.

### BACKGROUND OF THE INVENTION

This invention relates to a method and associated system for distributing video over a computer network.

Today, computers make it possible to provide massive amounts of entertainment and educational information to both commercial entities and consumers through the use of the Internet. In the last several years, there has been an explosion of growth in use of the Internet. Despite this explosion, the use of video on the Internet has been slow to develop. Recent events, however, point to tremendous expansion of this market as a natural progression in the use of the Internet. Current trends are paving the way for the use of video over the Internet and the use of video is becoming more attractive to both businesses and consumers.

The Internet has the power to transform society through unprecedented levels of information exchange with anyone who has a computer and is connected to the Internet. Currently, the Internet offers a variety of different services to users, including on-line trading, electronic databases, electronic mail, electronic newsletters and magazines, real time games, news services, job placement services, etc. Currently, most communication over the Internet occurs merely through text. This limitation in the format of information and entertainment stands in great contrast to the audio and/or visual presentation inherent in other electronic media such as television and radio. However, it is expected that as the explosive growth of multi-media continues, audio/visual programs will proliferate on the Internet and text will become less and less dominant in the on-line environment. Even though programs will be introduced that allow for audio/visual communication and entertainment, the Internet could remain essentially user-unfriendly due to its shear magnitude and its lack of organization, as well as to the randomness of the medium. Simply stated, there is no organization or direction on the Internet. Information is often difficult to find and harder yet is the ability to put any particular piece of information into a meaningful context.

In contrast to the Internet, television has been criticized for being a passive medium “chewing gum for the eyes.” Television has always been something that one watched, not something one did. Many social critics believe that the passivity that television viewing entails has seeped into our entire culture, turning a nation of citizen participants into a nation of passive spectators. While interactive television systems have increased the level of user interaction, and thus provided greater learning and entertainment opportunities, vast information resources such as databases are inaccessible from such a medium.

What is needed is a means to close the gap between video programming and the Internet. What is needed is a wider, richer experience integrating audiovisual and textual database elements into an organized unique interactive, educational entertainment experience. Currently, the Internet is a repository of information on virtually any subject. However, what is needed is a mechanism for combining the user-friendly visual experience of television with the vast information resources of the Internet while removing the seemingly complex intricacies of the Internet. Technology is at a point where consumers can now begin to leverage the power of the Internet and video, but first they must learn to use various tools. The following facts and trends point to the need for a system that provides consumers with the knowledge to leverage those tools:

Video is bandwidth-intensive (i.e., good picture quality requires a lot of data per frame).

Bandwidth cost and capacity are proportional to each other; video transmission is uneconomical unless one has scale.

Video requires tremendous storage capacity.

There are many fonnats (AVI, QuickTime, RealVideo, etc.) and standards (NTSC and PAL).

Most consumers do not understand how to use existing technology and are unaware of the requirements.

Current trends will make the use of video over the Internet a necessity to consumers:

Higher-speed networks will increase the ability to serve larger and clearer images

Faster dial-up modems and cable modems will significantly reduce the waiting time for downloading video and graphics from the Internet.

Costs of all hardware and software relating to video processing and editing will continue to decrease while improvements in these technologies will simplify their use.

The number of users of the Internet is growing rapidly and users are becoming more computer proficient.

The cost of serving video over the Internet will decrease.

At present, there is no Internet site that has penetrated the consumer segment on any scale. The use of video on-demand at large over the Internet is just beginning.

### OBJECTS OF THE INVENTION

An object of the present invention is to provide a method and/or an associated system for providing video over a computer network.

Another object of the present invention is to provide such a method and/or system for providing video over the Internet.

A further object of the present invention is to provide such a method and/or system wherein ordinary consumers are assisted in distributing home video clips to selected persons via the Internet.

Yet another object of the present invention is to provide a method and/or associated system whereby video clips may be distributed in an entertaining manner over the Internet.

A more particular object of the present invention is to provide a method and/or associated system whereby video clips may be distributed in conjunction with textual material over the Internet.

These and other objects of the present invention will be apparent from the drawings and descriptions herein.

### SUMMARY OF THE INVENTION

A video distribution method comprises (a) receiving, from each of a plurality of first parties over a computer network, at least one video clip, (b) storing the received video clips at a central location, (c) receiving requests from a plurality of second parties over the computer network, the requests each identifying a respective one of the first parties and concomitantly the respective video clip uploaded by that one first party for storage at the central location, and (d) transmitting, to each one of the second parties over the computer network, at least one video clip uploaded to the central location by a respective first party identified in the respective request from that one second party.

In a particular application of the video distribution method, the method further comprises (e) receiving from a selected one of the first parties a selection of a graphic illustration, and (f) in response to a request from a given one of the second parties, transmitting the graphic illustration over the computer network to that given second party. The request from the given second party may merely be a signal indicating that the given second party is ready to receive a message. In this application, the transmitting of video clips to the second parties over the computer network includes transmitting the video clip of the selected first party from the central location to the given second party over the computer network as a selected video clip viewable by the given second party on a computer monitor in temporal and spatial juxtaposition to the graphic illustration.

The video clip may be surrounded by the graphic illustration or, alternatively, disposed to the side of the graphic illustration on the computer monitor of the given second party. Where the graphic illustration is an animation, the graphic illustration includes at least one portion which appears as a moving graphic image on the computer monitor. In that case, the transmitting of the selected video clip to the given second party preferably includes transmitting the selected video clip so that at least a substantial portion of the selected video clip is viewable by the given second party on the computer monitor only after substantially all movement of the graphic illustration on the computer monitor has ceased. This sequential showing of the animation and the selected video clip is a preferred mode of communication of the selected video clip inasmuch as concurrent motion in the animation and the video clip is believed to be distracting to the viewer in most cases. However, it is within the contemplation of the present invention that a substantial portion of the selected video clip may appear on the computer monitor of the given second party concurrently with a moving portion of the animation. This concurrent presentation of animation and video may undertaken, for instance, where the motion in the animation is repetitive or at a substantially slower pace than the movement in the associated video clip. Other ways of synchronizing an animation and a video clip so that a viewer's attention easily accommodates both image sequences will occur to those skill in the art. Where motion in the animation is repetitive, the viewer does not feel a strong urge to focus on the animation during the playing of the video clip. In more complicated presentations of animation and video, the animation and video may be alternating in their action, with substantial portions of animation movement alternating with substantial portion of video presentation.

It is to be noted that the video clips uploaded to the central location and distributed to the second parties may incorporate audio as well as video. An audio component may also be provided in conjunction with any or all graphic illustrations or animations, particularly where the associated or co-transmitted video clips are devoid of audio content. The first parties may provide their own audio with the uploaded video clips or, alternatively, the first parties may select among a collection of prerecorded audio or sound bites stored at the central location. Thus, where a video clip has subject matter pertaining to a birthday celebration, the owner of that video clip may select a tune of the “Happy Birthday” song to be transmitted with the video clip and any associated animation. Where a particular video clip relates to a wedding, sound bite selections may include the usual wedding music.

In accordance with a feature of the present invention, the transmitting of the selected video clip to the given second party includes transmitting at least the substantial portion of the video clip only after receiving a start-transmission signal from the given second party. This start-transmission signal constitutes feedback from the viewer (i.e., the given second party) that the viewer has finished watching the graphic portion of the transmission and wishes to view the associated, selected video clip. This start-transmission feedback signal is believed to be particularly advantageous where the graphic illustration is an animation which is capable of captivating the attention of the viewer.

In carrying out this transmission mode, wherein a substantial portion of the selected video clip is transmitted only after receipt of a start-transmission signal from the viewer, an initial frame of the selected video clip is usually transmitted together with at least a terminal portion of the graphic illustration so that the initial frame (a photographic still image) of the video clip and the terminal portion of the animation appear simultaneously on the computer monitor. The computer screen display may additionally include a prompt or indication to the viewer that the still frame or photographic image is the beginning of a video clip. More specifically, a selector image may be displayed on the computer monitor together with the terminal portion of the graphic illustration and the initial frame of the selected video clip, the start-transmission signal resulting from a mouse-click by the viewer (the given second party) on the selector image.

In an alternative mode of transmitting the selected video clip and the animation to the given second party, at least a substantial terminal portion of the selected video clip is transmitted automatically after transmitting a terminal portion of the animation. Thus, an initial frame of the selected video clip may appear on the computer monitor of the given second party together with the animation and, at the termination of the animation, the remainder of the selected video is shown to the given second party. The termination portion of the animation may be preprogrammed with a trigger code which induces the automatic transmission and display of the selected video clip on the computer monitor of the given second party.

Pursuant to another feature of the present invention, the graphic illustration and the selected video clip are transmitted to the given second party through the use of streaming media technology.

The viewer (the given second party) of a video greeting card as described above is selected or identified by the first party who uploaded the selected video clip to the central location. Thus, an identification of the given second party is received prior to the transmitting of the graphic illustration to the given second party. The identification of the given second party may simply include an e-mail address of the given second party. Generally, it is contemplated that the given second party is notified via the identified e-mail address that a video greeting card, a video clip or a selection of video clips is available for viewing by the given second party via the computer network.

In accordance with another feature of the present invention, the transmitted graphic illustration is one of a plurality of previously created graphic illustrations stored at the central location. In this case, the video distribution methodology further comprises (1) transmitting to the selected first party an identification of the previously created graphic illustrations, and (2) receiving from the selected first party a selection of the one of the previously created graphic illustrations. The selected previously stored graphic illustration is transmitted to the given second party together with the selected video clip.

Pursuant to the present invention, any particular first party may upload a multiplicity of video clips to the central location, those video clips being grouped in a plurality of sets identified by the respective first party. Thus, a user of a video distribution service embodying the invention may upload a first set video clips categorized as birthdays, a second set of video clips categorized as weddings, a third set of video clips classified as vacations, and a fourth set of video clips categorized as Independence Day celebrations. The user may further customize the archiving and distribution of his or her video clips by dividing any set of clips into subsets corresponding exemplarily to a respective event. For instance, the clips in the birthday category may be further organized into subsets corresponding to the individual birthdays, such as Melinda's third birthday, Jackie's fifth birthday, Tom's eleventh birthday, etc. The video clips in any one of these event subsets represent individual scenes or specific episodes at the respective event. For instance, the subset of video clips of Jackie's fifth birthday may include a first clip showing Jackie in her new birthday dress, a second clip showing Jackie blowing out the candles, a third clip showing Jackie opening a present, and a fourth clip showing Jackie with chocolate cake on her birthday dress. The user or respective first party who uploaded these clips to the central location is provided with an opportunity to name the clips for purposes of facilitating access to the clips by a second party authorized by the user to download the clips.

Pursuant to the present invention, a plurality of identification codes assigned to or associated with respective ones of the second parties are received from a particular user or customer (first party). The identification codes each designate a respective set (generically including subsets) of the video clips of that particular first party which are permissibly viewed by a respective second party via the computer network. The transmitting of the video clips of the particular first party to the second parties then includes the transmitting of only those video clips designated as permissibly transmittable to the respective second parties. This feature of the present invention implements a customizable filtering or screening technique, whereby various prospective viewers (second parties) are blocked from witnessing those video clips which are not designated in the respective identification codes received from the first party user who uploaded the video clips to the central location. In an example of this feature of the present invention, a message or set of instructions from a first party user might include an e-mail address of a target second party and an identification of one or more sets of video clips which are open to viewing by that second party. The identification may designate one or more categories, events or entries. Preferably, when a line of communication is established with a target second party, that party is apprised of only those sets of video clips which that party may view. The party is not apprised of the existence of any other individual video clips or sets thereof.

Where the computer network is the Internet, the methodology of the invention further comprises providing an individual or dedicated Web page for each of the first parties. Each of the Web pages includes a background image and a plurality of alphanumeric video clip identifiers each designating at least one video clip of the respective one of the first parties. More specifically, the video clip identifiers may identify the video clip categories named by the individual first party users. Thus, a first party user may have a background image of a geographical map, with areas on the map labeled with such category names as “Birthdays,” “Weddings,” “Vacations,” and “Fourth of July.” Subsidiary or secondary Web pages may be provided for these category names so that when a visitor to the Web site clicks on one of the category names, a second map or other background image appears on the visitor's computer monitor, with areas designated by the respective event names corresponding to the selected category. For example, if “Birthdays Birthday,” “Jackie's Fifth Birthday,” “Tom's Eleventh Birthday,” etc.

Pursuant to the customizable filtering technique discussed above, where a particular second party invitee or visitor to a first-party user's Web page has been restricted to only certain categories by the first party owner of that Web page, the Web page communicated to the particular second party via the Internet does not include the names of the categories (or events or entries) which have been excluded from viewing by that second party. The restricted categories (events, entries) are simply deleted or omitted from the first party user's Web page prior to its transmission over the Internet to the computer of the particular second party.

The present invention contemplates that the Web pages of the individual users (first parties) are customizable by the users. Accordingly, the method includes receiving from each individual user a selection of the background image, a selection of the video clip identifiers, and an indication of preferred locations of the video clip identifiers on the background image. The providing of the respective Web page for the individual user includes superimposing the respective selected video clip identifiers on the selected background image at the locations selected by the one of the first parties. The background images may be selected from a library of background images or may be uploaded by the respective users. Alternatively, the users (first parties) may upload their own background images to the central location. Background images may be graphical or photographic so that the invention contemplates a wide variety of looks and approaches. Further examples include images of skyscrapers, architectural floor plans, family photo albums, children's swing sets, planetary systems, sailing ships and ocean liners, buildings with banners or flags, etc. In the latter case, the category, event or entry names or identifiers selected by the first parties may be superimposed on the banners or flags.

In accordance with another feature of the present invention, the video distribution method further comprises receiving a video edit instruction from a particular user after receiving from that user a respective video clip, and automatically editing the respective video clip in response to the video edit instruction. The edited video clip is stored in the central location. The invention also contemplates transmitting directions over the computer network for editing video clips on line, with the changes to the video clips being made at a predetermined location (e.g., server computer). This transmission of directions is implemented generally after receiving the video clips. An edited video clip is transmitted to the respective individual user prior to storage of the edited clip at the central location, for example, for purposes of permitting the user to accept or reject the edited clip.

To facilitate the editing of video clips, the method may also comprise transmitting a clip calculator to the users. The clip calculator includes pre-established text fields for the entry or inputting of numerical video clip parameters by the first parties. The video clip calculator provides the first parties with calculated video clip values in response to the entry or inputting of the numerical video clip parameters by the first parties.

A video distribution system comprises, in accordance with the present invention, a server computer linked to a computer network for receiving, from each of a plurality of first parties over the computer network, at least one video clip and for receiving requests from a plurality of second parties over the computer network, the requests each identifying a respective one of the first parties and concomitantly the respective video clip uploaded by the one of the first parties. The system further comprises a video database operatively connected to the server computer for storing the received video clips at a central location. The server computer includes a transmission module operatively linked to the database and to the computer network for transmitting, to each one of the second parties over the computer network, at least one video clip stored in the database by a respective one of the first parties identified in the respective request from the one second party.

In accordance with another feature of the present invention, the server computer further includes (1) an additional database storing a multiplicity of graphic illustrations and (2) a video greeting card unit operatively linked to the video database, the additional database and the computer network for selecting a video clip from the video database and a graphic illustration from the additional database in response to instructions received over the computer network from an individual one of the first parties and for transmitting the selected graphic illustration and the selected video clip over the computer network to an addressee identified in the instructions from that individual first party.

Preferably, the video greeting card unit includes a timing module for ensuring that the selected video clip is viewable by the addressee on a computer monitor in temporal and spatial juxtaposition to the selected graphic illustration. Where the video greeting card unit includes streaming media transmission componentry for transmitting the graphic illustration and the selected video clip to the addressee, the timing module is connected at least indirectly to the streaming media componentry for controlling the mixing of the signals of the graphic illustration and the selected video clip.

Where the graphic illustration is an animation including at least one portion which appears as a moving graphic image on the computer monitor of the addressee, the timing module includes means for ensuring that at least a substantial portion of the selected video clip is viewable by the addressee on the computer monitor only after substantially all movement of the graphic illustration on the computer monitor has ceased. More specifically, the timing module may include a delay component operatively connected to the video database and the computer network for transmitting at least the substantial portion of the video clip to the addressee only after receiving a start-transmission signal from the addressee. The timing module may additionally include a freeze-frame component or frame grabber operatively linked to the video database and the computer network for transmitting only an initial frame of the selected video clip together with at least a terminal portion of the graphic illustration to the addressee via the computer network so that the initial frame of the video clip and the terminal portion appear simultaneously on the computer monitor. The video greeting card unit optionally includes an image control module for transmitting a selector image which is displayed on the computer monitor of the addressee together with the terminal portion of the graphic illustration and the initial frame of the selected video clip, the start-transmission signal resulting from a mouse-click by the addressee on the selector image.

In accordance with an alternative feature of the present invention, the timing module includes a trigger module transmitting at least a substantial terminal portion of the video clip automatically after transmitting a terminal portion of the animation.

The server computer may further include addressing circuitry for identifying an e-mail address of the addressee from the individual first party's instructions prior to the transmitting of the graphic illustration to the addressee.

Where the graphic illustration is one of a plurality of previously created graphic illustrations stored at the central location, the server computer further includes (a) a graphics identification module transmitting to the individual first party an identification of the previously created graphic illustrations and (b) a graphics selection module receiving from the individual first party a selection of the one previously created graphic illustration prior to the transmitting of that one graphic illustration to the addressee.

Pursuant to a further aspect of the present invention, the server computer further includes a decoder operatively connected to the computer network for receiving and recognizing from at least a particular first party a plurality of identification codes assigned to or associated with respective ones of the second parties. The identification codes include a contact address, e.g., an e-mail address, for the selected second parties.

The server computer preferably includes a categorizing module operatively connected to the computer network and the video database for ordering, in groups in the video database, a plurality of video clips received from the particular first party. The groups of video clips are defined by the particular first party. In addition to e-mail addresses of selected second parties, the identification codes from the particular first party each designate at least a respective one of the groups of the video clips of the particular first party which are permissibly viewed by the respective selected second party via the computer network. The server computer then includes a filter or screening component so that the transmitting of the video clips of the particular first party to the respective selected second parties includes the transmitting of only those video clips designated by the particular first party as permissibly transmittable to the respective second parties.

This filtering or screening component of the server computer permits a user to easily control the distribution of multifarious video clips to a plethora of recipients.

Where the computer network is the Internet, the server computer further includes a Web-site management unit providing a Web page for each of the first parties wherein each Web page includes a background image and a plurality of alphanumeric video clip identifiers each designating at least one video clip of the respective one of the first parties. The Web-site management unit may be connected to or include a separate database dedicated to preserving various Web-page parts and identifying information. This Web-page database stores a selection of background illustrations or photographs, as well as names of categories, events, and entries as 5 defined by the respective users. These names for groups of video clips and individual clips include memory addresses for the respective video clips in the video database.

The Web-site management unit includes a decoding component operatively connected to the Internet and the Web-page database for eliciting video clip groupings and names from the individual users, as well as a selection of a Web-page background, locations on the background of the names of video groupings, and other parameters such as typeface, colors, etc. Superposition or Web-page generation componentry of the Web-site management unit controls the appearances of the Web-pages of the user parties so that the respective selected video clip identifiers are superimposed on the selected background image at the locations selected by the users.

The filtering or screening component enables or induces the selective transmission of the video clip identifiers to the second parties so that at least one such recipient is apprised of only a portion of the video clips received at the central location from a given one of the first parties. This selective communication of the video clip identifiers to the recipient parties is preferably implemented by simply deleting the names of the restricted categories, events, or individual entries from the information transmitted over the computer network to the recipient parties. More specifically, the Web-page generation componentry is supplied by the Web-page database with the identifiers and memory locations of only those video clips which are permissibly viewed by any particular recipient party.

In accordance with another feature of the present invention, the server computer further includes a video edit module operatively connected to the computer network and to the video database for automatically editing a video clip in response to a video edit instruction received from one of the first parties. An instructional module may be included in the server computer for transmitting to the first party users directions for editing a video clip on line. The video edit module is operatively connected to the transmission module for transmitting the edited video clip to the respective first party user prior to storing the edited video clips at the central location, for purposes of enabling confirmation of the edit from that first party user.

The method and the system of the present invention facilitate the use of “on-demand” (as oppose to “broadcast”) video programming by consumers over the Internet. The method and the system allow any consumer with access to a video camera and the Internet the ability to archive, post, distribute, and view any video content they desire (e.g., wedding clips, little league highlights, baby video, sweet 16's, etc.) on the Internet. The method and the system allow the user to share the video clips with friends, family or anyone in a systematic manner. Large volumes of video may be archived online. The video volumes can take the form of an online video diary or journal, thus providing the organization and eliminating the “randomness” of the Internet. The method and the system provide consumers with a new and powerful educational and entertainment medium. The method and the system allow consumers to post and view content over the Internet easily, inexpensively and efficiently and with the knowledge that the content of the consumer's videos is secure from unwanted viewers.

A core service contemplated by the present invention is an empowerment vehicle for educating consumers and providing them with quick access to the tools and methods for placing their own video content online instantaneously. The empowerment module will remove the “unknowns” and tedium that may be inherent in the process for posting and distributing video to the Internet. Users will be able to access a “tutorial” that will literally show them how to take analog video and post it to the Internet in a manner that is efficient for distribution and viewing. Currently, there are no Web sites that provide a single source solution for posting and distributing video to the Internet. The object of this empowerment module is to remove what is perceived as a complicated technology driven function and break that function down into simple, easy-to-understand tasks that the average person can comprehend and execute. The information provided in the tutorial is available on the Internet, but only to those who have the time and the desire to seek out the various sites where such information is available.

The system will empower/teach users to how to take video from a regular video camcorder and convert the video to a digital format, how to edit video clips including adding text scenes and music, and how to convert digital footage for e-mail distribution.

### BRIEF DESCRIPTION OF THE DRAWINGS

FIG. 1 is a block diagram of a computer network including a server computer for implementing a video distribution methodology in accordance with the present invention.

FIG. 2 is a block diagram showing selected functional modules of the server computer of FIG. 1.

FIG. 3 is a block diagram depicting in part functional modules of a Web site manager and a greeting card unit shown in FIG. 2.

FIG. 4 is a flow chart diagram of a process flow for customizing a journal display or Web page of a user in a video distribution method pursuant to the present invention.

FIG. 5 is a flow chart diagram of a process flow for maintaining and updating an access control list of authorized viewers of an uploaded video clip collection in a video distribution method pursuant to the present invention.

FIG. 6 is a flow chart diagram of a process flow for adding and modifying subsets of an uploaded video clip collection in a video distribution method pursuant to the present invention.

FIG. 7 is a flow chart diagram of a process flow for adding and modifying subsets of another level of an uploaded video clip collection in a video distribution method pursuant to the present invention.

FIG. 8 is a flow chart diagram of a process flow for sending e-mail invitations to view uploaded video clips in a video distribution method in accordance with the present invention.

FIG. 9 is a flow chart diagram of a process flow for creating a video greeting card, in accordance with the present invention.

FIG. 10 is a flow chart diagram of a routine shown in FIG. 9 for editing a video greeting card, in accordance with the present invention.

FIG. 11 is a flow chart diagram of a routine shown in FIG. 9 for deleting a video greeting card, in accordance with the present invention.

FIG. 12 is a flow chart diagram of a routine shown in FIG. 9 for building or generating a video greeting card, in accordance with the present invention.

FIG. 13 is a flow chart diagram of a routine shown in FIG. 9 for generating a mass personalization of a video greeting card, in accordance with the present invention.

FIG. 14 is a flow chart diagram of an empowerment module routine carried out by the server computer of FIG. 1, in accordance with the present invention.

### DESCRIPTION OF THE PREFERRED EMBODIMENTS

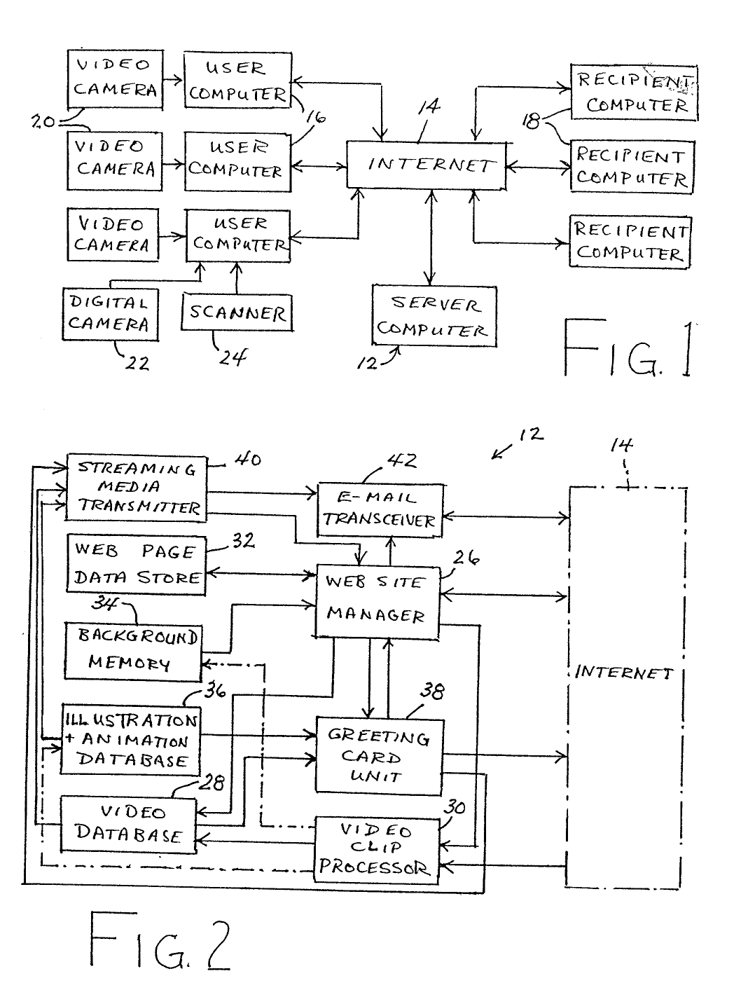

FIG. 1 depicts a server computer 12 linked to the Internet 14 for carrying out a video distribution process wherein individual users of the process upload video clips to server computer 14 from their respective personal computers 16 via the Internet 14. Subsequently, server computer 12 selectively transmits the uploaded video clips to personal computers 18 of recipients designated by the users. Server computer organizes and controls the storage and distribution of multiple video clips uploaded from each user computer 16.

The video clips, optionally including audio, are initially generated by video cameras 20. Video cameras 20 are connected to respective user computers 16 which are used in part to prepare the clips for uploading via the Internet 14 to server computer 12. Where cameras 20 generate analog video signals, an analog-to-digital converter (not shown) may be provided for transforming the analog video signal into digital format. One or more user computers 16 may be additionally connected, if only temporarily, to a photography camera 22 and/or a scanner 24 for enabling the uploading of one or more background images to server computer 12 for inclusion in a personal Web page or journal display for the individual user.

It is contemplated that server computer 12 notifies the various intended recipients of the video clips that a video clip is available for viewing by them. This notification is sent to e-mail addresses of the recipients, those addresses being identified by the users in instructions transmitted over the Internet 14 to server computer 12.

Server computer 12 maintains a site on the World Wide Web which is accessible to various user computers 16 and recipient computers 18. When a recipient wishes to view a video clip from a user, the recipient enters the video distribution Web site maintained by server computer 12 and, upon communication of appropriate identification information, is presented with a Web page or journal display associated with that user. Via the presented Web page, the recipient then selects which video clip or clips he or she wishes to view and orders transmission. As discussed hereinafter, each user not only identifies authorized viewers of the user's video clips but also prescribes which video clips of the user are permissibly viewed by each authorized viewer or recipient. The user's Web page as communicated to any particular authorized viewer or recipient contains names or identifiers of only those video clip groupings or individual video clips which have been indicated by the user as permissibly viewed by that particular authorized viewer or recipient.

As illustrated in FIG. 2, server computer 12 includes a Web site manager 26 operatively connected to the Internet 14 for generating personal Web pages and transmitting those Web pages to the various user computers 16 and recipient computers 18. Web site manager 26 also receives, from user computers 16, instructions regarding the formatting and construction of the users' personal Web pages and, from recipient computers 18, requests for access to selected user video clips. The users' video clips are stored in a video clip database 28 which is connected to the Internet 14 via a video clip processor 30. Processor 30 receives raw uploaded video clips from user computers 16 via the Internet 14 and converts the received video clips into a common predetermined format. Processor 30 is responsive to control signals received from Web site manager 26, whereby video clip processing operations are coordinated with user computers 16.

Server computer 12 further includes a Web page data store or database 32 operatively connected to Web site manager 26 for storing identification information pertaining to the various users and their designated video clip recipients. Web page data store 32 also contains (a) memory locations of the users' video clips in video database 28, (b) names or identifiers of categories defined by the various users for organizing their uploaded video clips, (c) the identities of the video clips in the selected categories, (d) e-mail addresses of authorized recipients, (e) identities of the video clips permissibly viewed by the designated or authorized recipients, and (f) the construction of the users' web pages, including the background images and category names or identifiers provided by the users.

Server computer 12 additionally includes a background memory 34 operatively coupled to Web site manager 26 for storing a collection of background images to be used in constructing the users' respective Web pages. Generally, the background images are preselected by the operator of server computer 12. However, it is possible for the users to upload their own background images to background memory 34. To that end, video clip processor 30 may be connected to background memory 34 for formatting incoming background images according to pre-established standard criteria prior to the storage of those images in memory 34. Background images for the Web pages of the individual users may be graphical or photographic and may include, for example, images of geographical maps, biological cell diagrams, skyscrapers, architectural floor plans, family photo albums, children's swing sets, planetary systems, sailing ships and ocean liners, transmission gearing, buildings with banners or flags, etc. The names or identifiers of a user's video clip categories are disposed superimposed in readable form on the respective background image in locations selected by the respective user. For example, where the background image is a map, the user may specify that category names such as “Birthdays,” “Weddings,” “Picnics,” “New Year Celebrations,” “Halloweens,” etc., are placed on the map in distributed regions on a land mass (or even in a body of water). Where the background image is of a large building with banners or flags outside, the user's category names may be superimposed on the banners or flags so that the words look like they are supposed to be on the banners or flags. Various digital processing techniques may be used by Web site manager 26 to incorporate a user's selected alphanumeric category names or identifiers into a chosen background image so that the category names or identifiers appear to have been part of the original image. This technique is especially effective where the background image is a photograph or a well-known public-domain picture.

As further illustrated in FIG. 2, server computer 12 additionally includes an illustration and animation database 36 and a greeting card processing unit 38. Greeting card unit 38 is operatively tied to the Internet 14, Web site manager 26, video database 28, and illustration and animation database 36 for transmitting, to authorized recipient computers 18, video clips in combination with graphics or animation stored in database 36 and selected by the respective users, as determined by Web site manager 26. More specifically, greeting card processing unit 38 selects a video clip from video database 28 and a graphic illustration from database 36 in response to instructions received over the Internet 14 from a user computer 16 and transmits the selected graphic illustration and the selected video clip over the Internet 14 to a recipient or addressee computer 18 identified in the instructions from that user computer 16. It is to be understood that the illustrations and animation in database 36 may include prerecorded audio accompaniment. Optionally, database 36 or a separate database (not shown) may include audio clips which may be superimposed on or associated with video clips uploaded from a user computer 16. As discussed hereinafter with reference to the selection of video greeting card components, a user may be informed as to the available audio clips and provided with an opportunity to download at least some audio selections via the Internet 14 in preparation for selecting one or more audio clips to accompany an uploaded video clip when that video clip is transmitted to an authorized recipient.

Generally, graphical illustrations and animations contained in database 36 are preselected by the operator of server computer 12. However, it is also possible for a user to upload his, her or its own illustrative and animated material. To that end, database 36 may be connected to video clip processor 30 for receiving therefrom formatted illustrations and animations uploaded via the Internet 14 from user computers 16.

It is contemplated that video clips from video database 28 and video greeting cards from unit 38 are generally transmitted via streaming media technology to recipient computers 18. To that end, video database 28 and greeting card unit 38 are connected to a streaming media transmitter 40 in turn connected to the Internet via an e-mail transceiver 42. Transceiver 42 forwards video clips and video greeting cards to recipient computers 18 via the Internet 14.

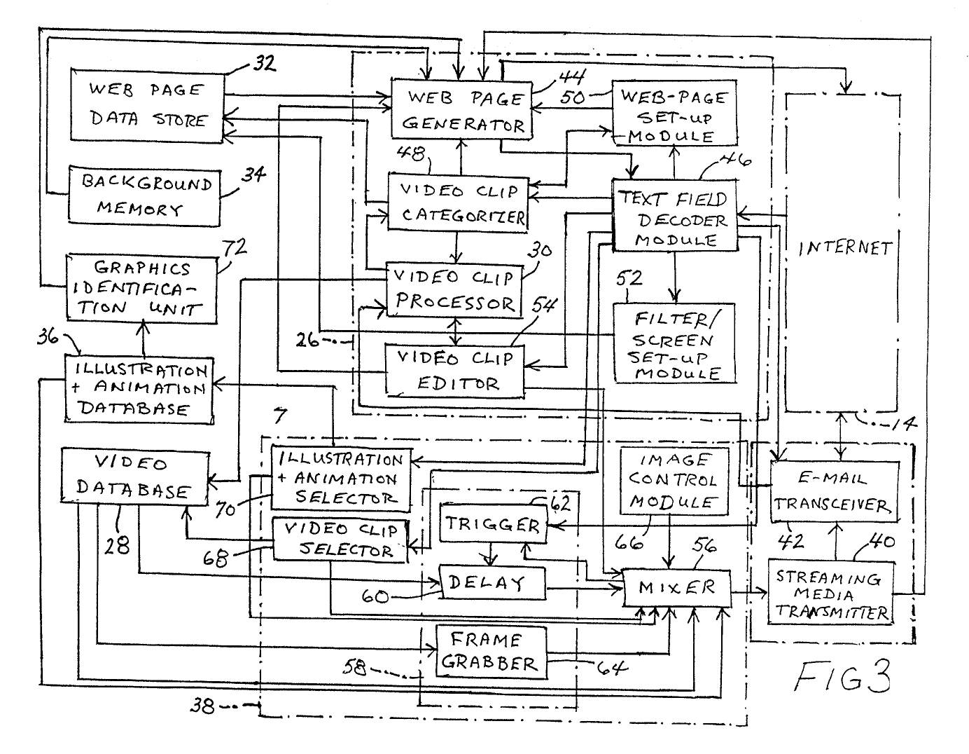

As illustrated in FIG. 3, Web site manager 26 includes a Web page generator 44 which is connected to the Internet 14 for providing a home page to user computers 16 and recipient computers 18. This home page informs potential users as to the operation of the video and greeting card distribution methodology, so that the potential users can make a decision as to whether to use the service. The home page assists new and existing users in the preparation of video clips in part by providing directions and informational guides to the users for educating the users and providing them with quick access to existing tools and methods for posting video content online instantaneously. An empowerment module (not shown) included in or connected to Web page generator 44 will enable users to download a “tutorial” that will show them how to post analog video to the Internet 14 and particularly to video processor 30 in a manner that is efficient for distribution and viewing.

The home page produced by Web page generator 44 also assists a new or existing user in setting up a personal Web page, e.g., defining video clip categories, selecting a background image, and positioning video clip category names on the background image. In addition, the home page assists an identified recipient in downloading one or more video clips permissibly viewed by that recipient. The home page generated by Web page generator 44 assists consumers by providing explanations, helpful illustrations and data entry fields for soliciting requisite information and preferences from individual users and recipients.

As further illustrated in FIG. 3, Web site manager 26 additionally includes a text-field decoder 46 which cooperates with Web page generator 44 in obtaining requisite information, preferences, and instructions from members the relevant consumer group, namely, users of the video distribution service and recipients of video clips. Text field decoder 46 is connected to the Internet 14 on an input side and to a video clip categorizer 48 on an output side. Video clip categorizer 48 is operatively connected at an output to video clip processor 30 in part to coordinate the operation thereof with transmissions of video clips from user computers 16. Video clip categorizer 48 also serves to place incoming or previously uploaded video clips in respective groupings defined by the respective user. The addresses of the various video clips in video database 28 are associated with their respective group names and stored therewith in Web page data store 32 by video clip categorizer 48.

In response to instructions received from a user computer 16 via the Internet 14 and decoder 46, video clip categorizer 48 may impose several levels of organization on a collection uploaded by the respective user. Each clip may itself be one of a plurality of “entries” in a video clip group or set called an “event.” Several events each comprising one or more entries may in turn be grouped in a “category.” Accordingly, a user's entire library of uploaded video clips may include several categories each comprising a set of one or more events which in turn are sets or groups of one or more video clip entries. In an example of video clip organization, categories of video clips may include birthdays, weddings, vacations, picnics, and Labor Day celebrations. The video clips in the birthday category may be further organized into subsets corresponding to events such as individual birthdays (Jerry's third birthday, Ellie's fifth birthday, Gary's eleventh birthday, etc.). The video clip entries in any one of these event subsets represent individual scenes or specific episodes at the respective event. For instance, the subset of video clips of Ellie's fifth birthday may include a first clip showing Ellie in a new birthday dress, a second clip showing her blowing out candles on a cake, a third clip showing her with a friend, and a fourth clip showing her with ice cream in her hair. The particular user provides names for the categories, events and entries, for example, “Jerry's Third Birthday” and “Jerry Falling in Cake.”

Video clip categorizer 48 stores, in Web page data store 32, the names or identifiers of video clip groupings as defined by the individual users. Data store 32 is linked to Web page generator 44 in part for supplying that unit with (a) an address of a background image selected by a user for his or her Web page, (b) the grouping names or identifiers, and (3) the locations and formats of the identifiers on the selected background image. The selection of the background image, as well as the locations and formats of the video clip grouping identifiers on the selected background image, is implemented via a Web-page set-up module 50. Module 50 is operatively connected to Web page generator 44, decoder 46, and video clip categorizer 48 for cooperating with those modules in setting up a user's Web page.

Web page generator 44 and decoder 46 also cooperate to obtain, from user computers 16, identification codes identifying recipients (and thus recipient computers 18) authorized to download the video clips of the respective users. More particularly, in addition to an e-mail address of a selected recipient, an identification code from a user computer 16 designates at least one video clip grouping of the respective user which is permissibly viewed by the identified recipient via the Internet 14. The uploaded identification codes recognized by decoder 46 in cooperation with Web page generator 44 are provided to a filter or screen set-up module 52 (FIG. 3) which is operatively connected to Web page data store 32 to load thereinto the identities (e-mail addresses) of selected recipients and the video clips groupings designated by the users as permissibly transmittable to the selected recipients.

When transmitting a Web page of a user to an authorized recipient, Web page generator 44 includes on the user Web page only the names or identifiers of those video clip groupings permissibly viewed by that authorized recipient. Thus, the recipient is not even made aware of the existence of video clips which the recipient is not authorized to view. Thus, filter or screen set-up module 52 of server computer 12 permits a user to easily control the distribution of his or her video clips to various authorized recipients.

As additionally illustrated in FIG. 3, server computer 12 further includes a video editor 54 operatively connected to the Internet 14 via decoder 46 and to processor 30 for controlling the processor to automatically edit a video clip in response to a video edit instruction received from a user computer 16. Edited video clips are stored in video database 28 after editing of the clips by processor 30 under the control of editor 54. An instructional module (not separately illustrated) optionally included in editor 54 is connected to Web page generator 44 for transmitting to user computers 16 directions for editing video clips on line. Edited video clips may be transmitted from video database 28 (e.g., via a mixer 56) to the respective users via streaming media transmitter 40 and transceiver 42. Alternatively, video clip editor 54 is operatively connected to streaming media transmitter 40 and transceiver 42 for transmitting edited video clips to the respective user computer 16 prior to storage of the edited clips in video database 28. In any case, users of this on-line editing service are provided with an opportunity to view the edited clips and to confirm the acceptability of the edited clips prior to transmission of those clips to authorized recipient computers 18 either alone or in combination with an illustration or animation in a video greeting card.

Streaming media transmitter 40 is operatively linked to video database 28 and to the Internet 14 for transmitting to any given recipient computer 18 over the Internet 14 at least one video clip stored in database 28 and identified in a request received from that given recipient computer. Generally, recipient computers 18 may obtain access to authorized video clips in any of several modes of transmission. In one mode, a video clip, either alone or in combination with a greeting card illustration or animation from database 36, is transmitted to a recipient computer 18 in a window of a Web page. To that end, streaming media transmitter 40 is connected to Web page generator 44. In an alternative mode of transmission, a video clip presentation window is generated by a browser program on the respective recipient computer 18. In that case, a selected video clip and optionally an associated fixed or moving graphic illustration are transmitted from streaming media transmitter 40 via transceiver 42.

Web site manager 26 and particularly decoder 46 are connected to e-mail transceiver 42 for transmitting e-mail messages to recipient computers 18 to notify the potential video recipients that they have been selected by respective users to receive certain video clips or video greeting cards. These e-mail messages transmitted to recipient computers 18 from server computer 12 indicate that uploaded video clips are available for viewing by the respective recipients. The email messages contain directions instructing the identified or authorized recipients as to the procedure for obtaining access to the uploaded video clips. These directions may merely direct the identified or authorized recipients to the Web home pages of server computer 12. Further instructions on the home pages guide the recipients in obtaining access to user Web pages wherein authorized video clip groupings are posted.

In an alternative procedure, user computers 16 notify recipient computers directly, e.g., via e-mail, as to the existence of downloadable video clips on the Web site maintained by server computer 12. These e-mail notifications contain the Web address of server computer 12, as well as an identification of the respective user and recipient, thus enabling the recipients to navigate through the Web site to obtain the permissibly downloadable video clips.

As further illustrated in FIG. 3, greeting card processing unit 38 includes a timing module which functions to ensure that a selected video clip is viewable by an authorized recipient on his or her computer monitor in temporal and spatial juxtaposition to a selected graphic illustration. Video greeting card unit is connected to streaming media transmitter 40 and transceiver 42 for transmitting the selected graphic illustration and the selected video clip to the computer 18 of the authorized recipient. Mixer 56 is connected on an input side to timing module 58, video database 28, and illustration and animation database 36 and on an output side to transmission components 40 and 42 for mixing the signals of selected graphic illustrations from database 36 and respective selected video clips from database 28. As discussed above, any particular video clip may be transmitted with a respective illustration or animation so as to appear within the boundaries of the illustration or animation or to appear beside the illustration or animation, e.g., spaced therefrom on the computer monitor of the authorized recipient. Thus, varying degrees of integration of the video clip and the illustration or animation are possible. In advanced techniques, portions of a video clip (such as a person's face) may be superimposed on a graphical or animation background. Alternatively, a graphical feature or animation part (e.g., an animated character) may be superimposed on a video clip to create the appearance of an interaction between the animated character and a real person in the video clip.

Timing module 58 includes a delay component 60 operatively connected to video database 28 and mixer 56 for ensuring that at least a substantial portion of a selected video clip is viewable by a recipient on his or her computer monitor only after substantially all movement of the associated graphic illustration on the computer monitor has ceased. Delay component 60 transmits at least the substantial portion of the selected video clip to the recipient computer 18 only after receiving a start-transmission signal from that computer. The start-transmission signal constitutes feedback from the viewer, i.e., an authorized recipient, that the viewer has finished watching the graphic portion of the video greeting card transmission and wishes to view the associated video clip.

To initiate transmission of the video clip portion of a video greeting card upon reception of a start-transmission signal from an authorized viewer, delay component 60 is connected to a trigger component 62 of timing module 58, the trigger component in turn being linked to decoder 46. The start-transmission signal is recognized by decoder 46 and relayed to trigger component 62. Trigger component 62 controls delay component 60 to transmit the selected video clip to mixer 56.

Timing module 58 also includes a freeze-frame component or frame grabber 64 operatively linked to video database 28 and mixer 56 for enabling the transmission of only an initial frame of a selected video clip together with at least a terminal portion of a selected graphic illustration (or animation) to an authorized recipient computer 18 via the Internet 14 so that the initial frame of the selected video clip and the terminal illustration portion appear simultaneously on the computer monitor of the authorized recipient computer 18.

Greeting card processing unit 38 optionally includes an image control module 66 operatively connected to mixer 56 for generating a selector image which is combined by mixer 56 with the selected graphic illustration and at least an initial portion of the selected video clip so that the selector image is displayed on the computer monitor of the recipient computer 18 together with the terminal portion of the graphic illustration and the initial frame of the selected video clip. The selector image constitutes a prompt or indication to the viewer or authorized recipient that a still frame or photographic image in a video greeting card transmission is the beginning of a video clip. The selector image may simply be a designated computer screen area where a mouse click results in generation and transmission of the start-transmission signal from the respective recipient computer 18 to server computer 12 and more particularly, decoder 46. The arrival of the start-transmission signal is communicated to trigger component 62 which then induces delay component 60 to transmit the selected video clip component of the video greeting card being viewed by the respective recipient computer 18.

In an alternative mode of operation, trigger component 62 receives, from mixer 56 or from a recipient computer 18 via decoder 46, a signal indicating that a graphic animation component of a video greeting card is nearing its end. Trigger component 62 then induces delay component 60 to automatically commence transmission of the video clip component of the video greeting card. Thus, it is possible for a sequential viewing of an animation and a video clip to be undertaken without intervening input by the recipient. In this automatic transmission mode for a video greeting card, an initial frame of the video clip may appear on the computer monitor of the viewer or authorized recipient together with the animation and, at the termination of the animation, the remainder of the selected video is automatically shown to the viewer or authorized recipient. The termination portion of the animation may be preprogrammed with a trigger code which induces the automatic transmission and display of the selected video clip on the computer monitor of the authorized recipient.

Greeting card processing unit 38 further includes a video clip selector 68 and an illustration and animation selector 70 each operatively connected at a respective input to decoder 46. In response to instructions from a user computer 16, video clip selector 68 and an illustration and animation selector 70 store addresses of a video clip and an illustration or animation selected by the respective user to form a video greeting card. Alternatively, these addresses or identification data pertaining to a video greeting card may be stored in Web page data store 32. Where a user has selected an audio clip to accompany a video clip, the identity of that audio clip may be stored in selector 68 or Web page data store 32. It is possible for a user to select different audio clips to accompany the same video clip to different authorized users.

When decoder 46 recognizes a request from an authorized recipient computer 18 for downloading of a video greeting card, decoder 46 alerts greeting card processing unit 38 and particularly selectors 68 and 78, timing module 58, and mixer 56. Those components then carry out the transmission of the selected card chosen previously by the respective user.

To facilitate selection of a prerecorded illustration or animation from database 36, server computer 12 includes a graphics identification module 72 operatively connected to database 36 for transmitting to user computers 16 identifications of the graphic illustrations and animations stored in database 36. To enable a user to view the prerecorded illustrations and animations, decoder 46 alerts illustration and animation selector 70 and mixer 56 that a selected illustration or animation is to be transmitted via streaming media transmitter 40 to a particular user.

An authorized recipient request detected via decoder 46 may mere identify a video clip or a grouping of video clips which the recipient may permissibly view via the Web site of server computer 12. In that case, video clip selector 68 is induced by decoder 46 to read a selected video clip from database 28 to streaming media transmitter 40 for relay to the requesting recipient. Video database may be directly connected to streaming media transmitter 40 to facilitate this transfer. Otherwise, selector 68 may control mixer 56 to pass the selected video clip through to transmitter 40.

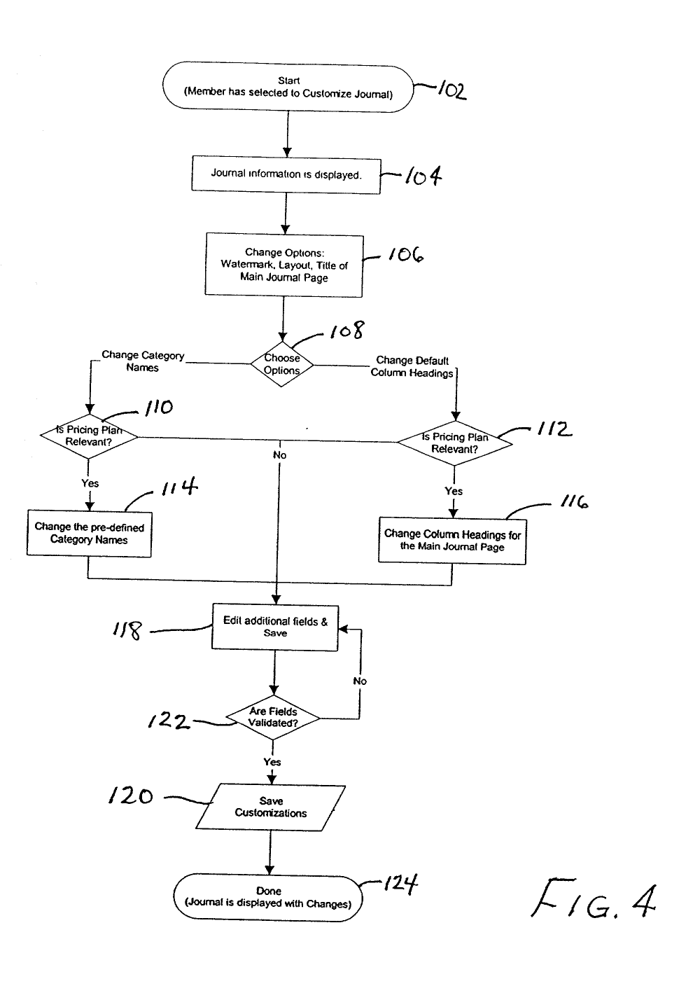

FIG. 4 depicts a flow chart diagram executed by server computer 12 for enabling a user to customize his or her personal Web page or journal display. Generally, to simplify the creation by a user of a personal Web page on the site maintained by server computer 12, a standard journal display may be provided. Any given user might elect to use this standard journal display as his or her personal Web page, with modifications or edits to identify the particular user. The modification or edit process is shown in FIG. 4. In a starting step 102, a user selects a customization option via the home page of the Server computer's Web ste. This election may be implemented, for instance, by the particular user clicking a mouse button on an appropriate menu option. User selection of the customization option, detected by decoder 46 (FIG. 3), leads to the transmission by Web page generator 44 of current journal information for the particular user in a step 104. In another step 106, Web page generator 44 provides the particular user with a list of possible changes to the user's personal Web page or journal display. The possibilities include changing a watermark or background image, a page layout, and a title of the user's main journal page. In an option detection step 108, Web page generator 44 and decoder 46 determine whether the particular user has elected to change category names or default column headings. In either case, server computer 12 undertakes a query 110 or 112 as to whether the particular user has paid for the requested customization option. If so, server computer 12 (particularly including Web page generator 44 and decoder 46) enters into a respective routine 114 or 116 enabling the particular user to change category names or column headings for the user's main Web or journal page. Thereafter, or if the user has not subscribed to the requisite payment plan, as detected by server computer 12 in queries 110 and 112, server computer 12 enters a routine 118 implementing other edits requested by the particular user. These edits or customizations are saved in Web page data store 32 in a step 120 if the edits are formally proper, e.g., conform to pre-established format requirements, as determined in at a decision junction 122. In a final step of the process flow of FIG. 4, the updated personal Web page(s) of the particular user is displayed with the changes in a step 124.

Further customization processes (mostly not illustrated) pertain to the selection and modification of video clip category names or identifiers. Pursuant to the data contained in Web page data store 32 for a particular user, Web page generator 44 causes the display on the user's computer monitor of existing category names for that user's journal display or personal Web page. As implied above, once a user signs up as a member or subscriber to the video distribution service, a standard or default personal Web page or journal display is assigned to the user. The default categories are then registered in data store 32. To change the listing of video clip categories in the standard journal page or to change a previously customized category, the user selects the desired category and chooses an option taken from the following: (a) adding and modifying the category, (b) copying the category, (c) deleting the category, (d) reclassifying events in the category, (e) maintaining an access control list, and (f) colinking video clips.

In adding a video clip category to a particular user's personal Web page or journal display, Web page generator 44 presents a user with a blank category form with fields to be filled in by the particular user. Where the user desires to modify a category, Web page generator 44 consults data store 32 to display category information on the user's machine. The user then selects an edit option and a category to modify.

Where a user wishes to set up another video clip category, he or she may select a preexisting category, copy that category, and then modify the copy. When copying a category which includes one or more event subsets, the user is presented with the option of copying the event names as well.

Where a user has selected a menu option to delete a video clip category, Web page generator 44 consults data store 32 to determine whether the selected category has associated events. These events, if any, are listed on the user's computer monitor to provide the user with the option of deleting the events or moving the events to one or more different categories.

If a user wishes to reclassify one or more video clips (events) from a first category to a second category, Web generator 44 presents to the user a list of the events in the first category to thereby enable the user to select the clip or clips the user wishes to reclassify under the second category. The user can either establish the second category as a new category or select a previously created category for receiving the reclassified video clip(s).

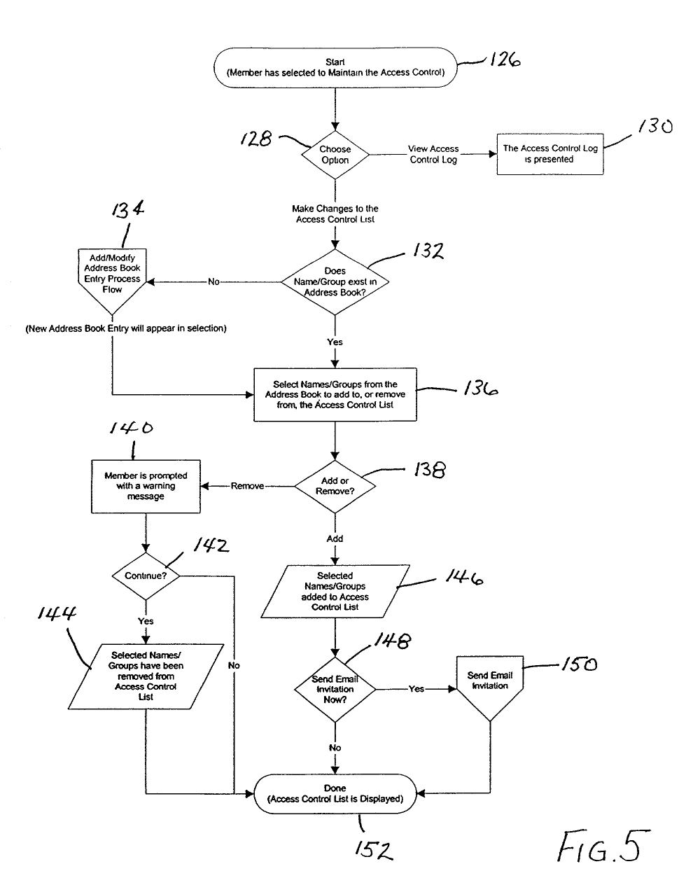

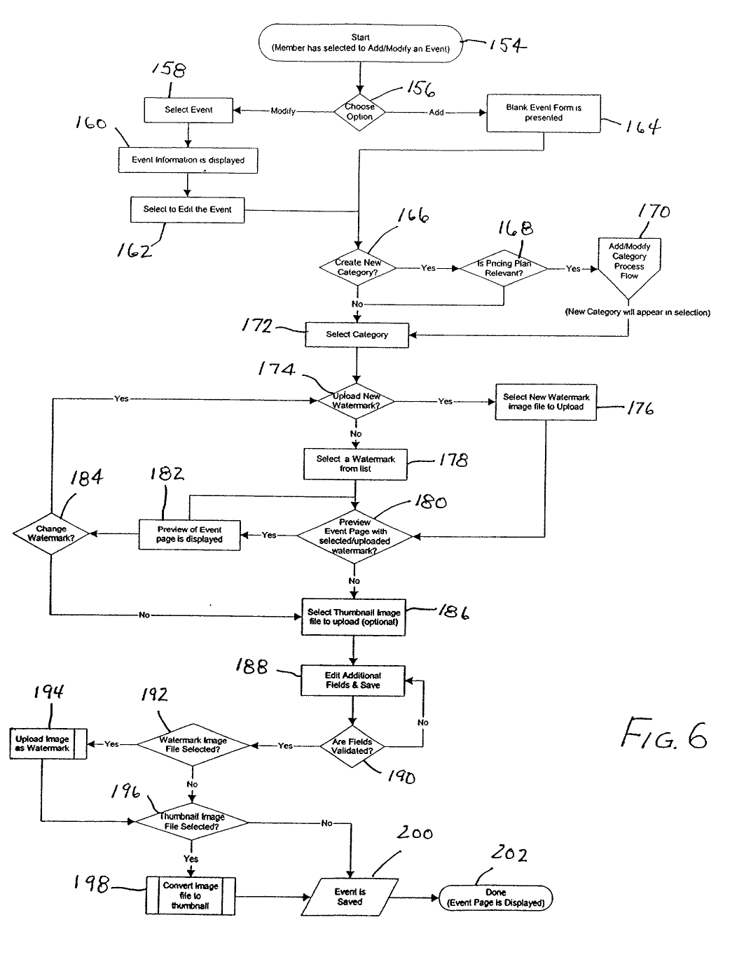

FIG. 5 depicts a flow chart diagram executed by server computer 12 for maintaining an access control list of any particular user. This list identifies those recipients who are authorized to view video clips of the particular user. In a first step 126, decoder 46 recognizes that the particular user wishes access to his or her access control information. Subsequently, in response to a signal from decoder 36, Web page generator 44 provides the particular user in a step 128 with selectable options including viewing the user's access control log and making changing in the user's access control list. Web page generator 44 consults Web page data store 32 to determine the user's access control log, which is presented to the user upon request in a step 130. Where the user wishes to modify the access control list, as determined by decoder 46 in step 128, server computer 12 (e.g., Web page generator 44 and decoder 46) determines in an inquiry 132 whether the particular user wishes to change access control information pertaining to a recipient who is already identified on the access control log. If the desired change pertains to adding a new recipient to the list of recipients authorized to receive video clips of the particular user, server computer 12 implements the addition to the access control log in a step 134. If the desired change pertains to a pre-existing authorized recipient, as determined at inquiry 132, server computer 12 obtains a selection of a listed recipient from the user in a step 136. Upon selection of a listed authorized recipient by the user, a determination is then made by server computer 12 at a decision junction 138 whether the user wishes to delete the selected authorized recipient or to change the access of the selected authorized recipient. A desire to delete results in a warning issued by server computer 12 to the user in a step 140, a check 142 that the user wishes to continue with the deletion, and a deletion step 144. Where the particular user wishes to change the access of the selected authorized recipient to the user's collection of uploaded video clips, the addition or removal of authorization or permission to selected video clip categories (and/or events and/or entries) is undertaken in a step 146. Server computer 12 then inquires at 148 whether the user wishes to have an e-mail invitation sent to the recipient whose access authorization has just been modified. An affirmative response from the user results in dispatch of the e-mail invitation pursuant to a routine 150. Then the revised access control list or log is displayed to the user for review in a step 152.

Server computer 12 may provide to any given user the option of linking his or her personal Web journal page or one or more uploaded video clips to another Web site on the Internet 14, for purposes of enabling access from that other site via a hypertext link. Server computer 12 obtains a URL for the target video clip of the given user and the user enters an expiration date for the link. The link information is saved by server computer 12, while the URL is presented to the given user to copy and paste into the other Web site.

Related additional customization processes (mostly not illustrated) pertain to the selection and modification of video clip event names or identifiers. Pursuant to the data contained in Web page data store 32 for a particular user, Web page generator 44 causes the display on the user's computer monitor of existing event names for that user's journal display or personal Web page. As discussed above, a standard or default personal Web page or journal display is assigned to each user, member, or subscriber of the video distribution service carried out by server computer 12. Default events may be included as subsets of the default categories registered in data store 32. To change the names or listings of video clip events, a user selects the desired event and chooses an option taken from the following: (a) adding and modifying the event, (b) copying the event, (c) deleting the event, (d) reclassifying entries in the selected event, (e) maintaining an access control list (described above), and (f) colinking video clips (described above).

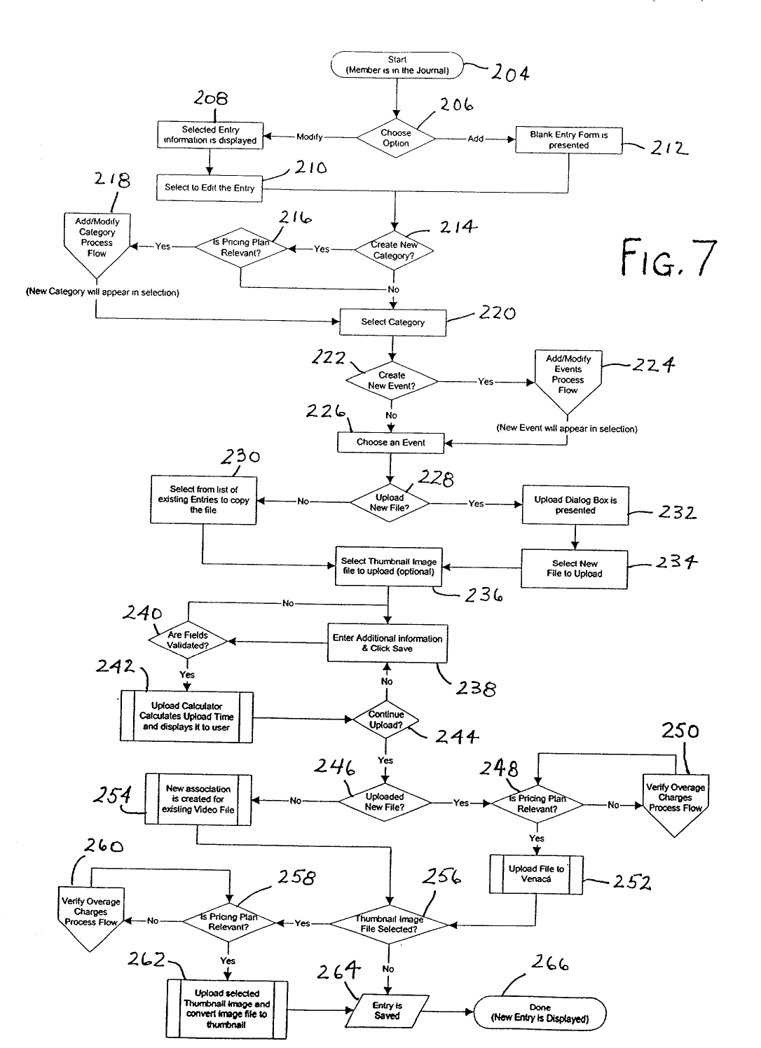

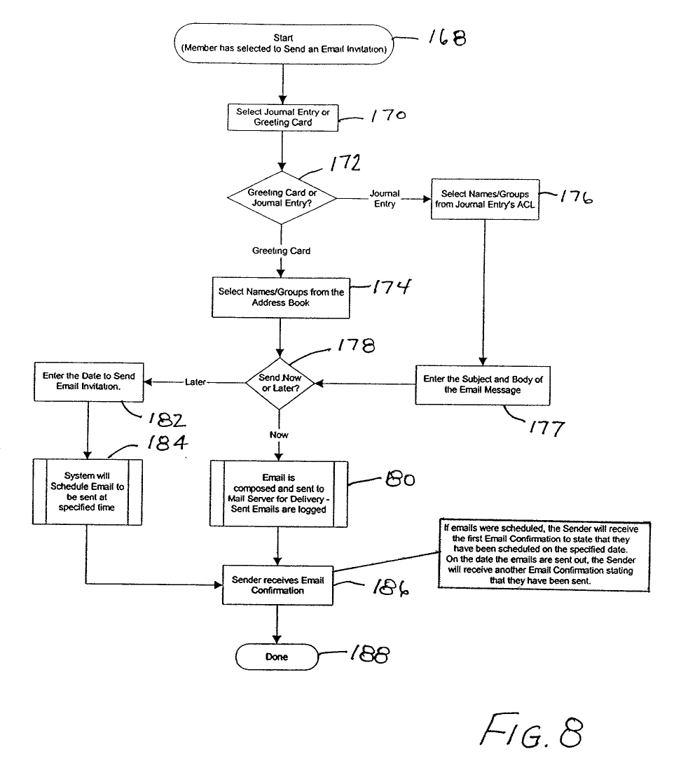

As depicted in FIG. 6, server computer 12 is notified in a step 154 that a particular user wishes to add or modify a video clip event in the user's uploaded video clip collection. More particularly, decoder 46 (FIG. 3) in conjunction with Web page generator 44 detects a signal from the user encoding an event editing request. At a first decision junction 156, the server computer 12 (i.e., Web site manager 26 and more particularly Web page generator 44 and decoder 46) determines whether the particular user wishes to modify an event or to add an event. In the former case, server computer 12 monitors a selection by the user of a desired event in a step 158, presents the relevant event information to the user in a step 160, and receives an edit request in a step 162. In the latter case, server computer 12 presents a blank event form to the user in a step 164. Subsequently, server computer 12 asks the user in an inquiry 166 whether the user desires to create a new category for the event. If so, the user's pricing plan is checked at 168 to determine whether such a modification is permissible. If the user has indeed paid for such an option, the adding or modification process is carried out in a routine 170. If the user wishes to use a pre-existing category, as determined at inquiry 166, or if the user has not paid for category modification, as determined at check 168, server computer 12 provides the user with a category list and obtains a selection of a category in a step 172. At a following decision junction 174, server computer 12 determines whether the user wishes to upload a new watermark or background image. An affirmative determination results leads to uploading of a new watermark or background image in a step 176. A negative determination leads to selection (step 178) of a watermark or background image from those in background database 34. Regardless of how the background image is obtained, the user is then asked in a query 180 whether he or she wishes to preview the event page with the uploaded or selected watermark or background. A positive response to query 180 results in a preview 182 of the event page and an option 184 to change the watermark or background image. Once the user is satisfied with the event page, as determined by a negative response to query 180 or option 184, the user is optionally permitted at 186 to select a thumbnail image file to upload. Additional fields for the event page are then edited and saved in a step 188. Server computer 12 performs a check 190 to ascertain that the fields are properly completed. Upon a proper completion of the fields, server computer 12 undertakes a check 192 as to whether a watermark image file was selected? If so, server computer 12 uploads the image as watermark in a step 194 and subsequently inquires at 196 whether a thumbnail image file was selected. A positive result to inquiry 196 leads to conversion of the image file to a thumbnail file in a step 198. Finally, the event is saved in a step 200 and displayed in a step 202.

Where a user wishes to set up another video clip event, he or she may select a pre-existing event, copy that event, and then modify the copy. When copying an event which includes one or more entry subsets, the user is presented with the option of copying the entry names as well.

Where a user has selected a menu option to delete a video clip event, Web page generator 44 consults data store 32 to determine whether the selected event has associated entries. These entries, if any, are listed on the user's computer monitor to provide the user with the option of deleting the entries or moving the entries to one or more different events or categories.

If a user wishes to reclassify one or more video clips (entries) from a source event to a target event, Web generator 44 presents to the user a list of the entries in the source event to thereby enable the user to select the clip or clips the user wishes to reclassify in the target event. The user can either establish the target event as a new event or select a previously created event for receiving the reclassified video clip(s). Server computer 12 recalculates the total running time of file size for the video files in each entry of the source and target events. The file size and total running time are saved with the source and target events.

Customization of a user's personal Web page or video journal display additionally includes (a) adding and modifying a selected video clip entry, (b) copying a selected entry, (c) deleting a selected entry, (d) reviewing deposited video clips, (e) building a video greeting card, (f) designating video clips as “daily features,” (g) viewing a viewer log, and (h) viewing uploaded video clips.

FIG. 7 depicts a process flow for modifying or adding a video clip entry. After an initialization step or steps 204, server computer 12 (Web site manager 26 and more particularly Web page generator 44 and decoder 46) monitors an option selection by the user at a decision junction 206. A decision to modify a video clip entry leads to a display of information pertaining to a selected entry in a step 208 and an edit selection in a step 210. A decision to add a new entry leads to the presentation of a blank entry form to the user by server computer 12 in a step 212. Subsequently, server computer 12 queries at 214 whether the user wishes to create a new category for the subject video clip entry. If the user is interested in creating a new category, server computer 12 checks at 216 whether the particular user has subscribed to a plan which covers the addition and modification of categories. If so, the server computer processes the desired addition or modification in a routine 218 (same as routine 170). At the termination of routine 218, or in the event of a negative response to query 214 or a failure of check 216, server computer 12 implements a category selection in a step 220.

After the selection of a category in step 220, server computer inquires at 222 whether the user wishes to create a new event for the subject video clip entry. If the user is interested in creating a new event, server computer 12 processes the desired addition or modification in a routine 224 and hereafter implements an event selection in a step 226. At a following decision junction 228, server computer 12 asks the user whether he or she wishes to upload a new file for identifying or defining the new video clip entry. A negative response leads to a step 230 in which the user selects from a list of existing entries and server computer 12 copies the file of the selected entry. A positive response at decision junction 228 leads to a step 232 in which an upload dialog box is presented over the Internet 14 to the particular user. Then, in a step 234, a new file to upload is selected.

As further depicted in FIG. 7, the user is optionally permitted at 236 to select a thumbnail image file to upload. Additional information is entered by the user in a step 238. This information is checked at 240 to determine validity, completeness and acceptability of the entered information. Upon a positive outcome to check 240, server computer 12 consults a clip calculator previously transmitted to the user, e.g., by Web generator 44. The clip calculator includes text fields for the entry or inputting of numerical video clip parameters by the user. The input clip parameters are detected by decoder 46 and used by server computer 12 to calculate video clip upload time in a step 242. Server computer 12 may include a separate functional module (not shown) operatively connected to Web page generator 44 and decoder 46 for providing the clip calculator to the respective user computer 16 (FIG. 1), for computing the video clip upload time and for communicating the computer video clip upload time to the user (step 242). After computation and communication of the clip upload time to the particular user, server computer 12 asks the user at 244 whether the user wishes to continue with the upload. If not, the server returns the user to step 238 for enabling the user to change the particulars of the contemplated video clip entry. If so, server computer 12 makes a determination 246 whether the entry change made by the user is a new video clip file or a modification to an existing entry. If the clip is a new file, server computer 12 institutes a check 248 as to whether the pricing plan of the user permits a file upload. If the outcome to check 248 is negative, overage charges are verified in a routine 250. If the outcome is positive, the file is uploaded to the server computer in a routine 252.

If the entry change made by the user is a modification to an existing entry file, as determined by server computer 12 at 246, a new association is created in a step series 254. Then, server computer 12 inquires at 256 whether a thumbnail image file was selected. A positive result to inquiry 256 results in a check 258 whether the particular user has subscribed to a plan which covers thumbnail file uploads. If the outcome to check 258 is negative, overage charges are verified in a routine 260. If the outcome is positive, the selected thumbnail image is uploaded to the server computer 12 and converted to a thumbnail file in a routine 262. The added or modified entry is saved in a step 264 and displayed to the respective user in a step 266.

Where a user wishes to set up another video clip entry, he or she may select a pre-existing entry, copy that entry, and then modify the copy. The user is provide also with the option of copying the video clip corresponding to the particular entry. The user may also be with the option of copying multiple video clips in an event when copying the event or even copying multiple video clips when an entire category is being copied.

Where a user has selected a menu option to delete a video clip entry, Web page generator 44 consults data store 32 to determine whether the selected entry has associated greeting cards. Identifications of associated greeting cards and other pertinent information are provided to the user prior to effectuating entry deletion. After the user has confirmed his or her desire to delete a video clip entry, the entry as well as any associated thumbnail image file and any associated greeting card is deleted. The video clip itself is deleted only if it is not associated with any other entries. (The same video clip may be named as an entry in different events and/or categories. For instance, a video clip relating to a birthday celebrated at a seashore picnic on Independence Day might be an entry under the categories of Birthdays, Picnics, Ocean Visits, and Independence Day Gatherings.)

For a user to review a deposited video clip, server computer 12 provides the user with a list of deposited or uploaded video clips. The user selects a desired video clip, views the clip and subsequently has the option of approving the video. If the video has been prepared by another service company, the user has an opportunity of communicating his or her objections to that company. Otherwise, if the video clip is acceptable, the user may be provided at that juncture with an opportunity of adding the clip as an entry in another event or category or modifying the entry name or identifier the video clip in the same event.

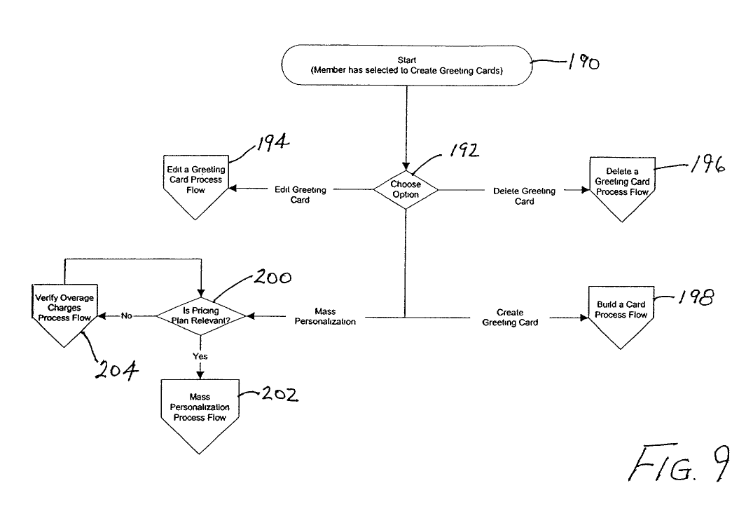

FIG. 8 is a flow chart diagram of a process flow executed by server computer 12 for sending e-mail invitations to recipient computers 18 inviting prospective or potential viewers to download video clips stored in video database 28 (FIG. 1). In a step 168, server computer 12, particularly decoder 46 in conjunction with Web page generator 44, recognizes the reception from a user computer 14 of a request to dispatch an e-mail invitation. In a subsequent step 170, Web page generator 44 generates a menu selection or other communication transmitted to the particular user and receives an indication from that user of the subject matter selected by the user of the incipient or requested e-mail transmission. In a decision junction 172, server computer 12 determines whether the e-mail transmission request pertains to a video clip (journal entry) by itself or a video greeting card incorporating a video clip. In either case, server computer 12 obtains, from the respective user in a step 174 or 176, a selection of individual recipient names (or e-mail addresses) or groups of names (addresses). Pursuant to conventional e-mail transmission methodology, the selection of desired e-mail recipients may be obtained by server computer 12 from an address book previously generated or uploaded by the particular user. Where the user desires to transmit an invitation to view a video clip alone, as determined at decision junction 172, the user is provided in a step 177 with an opportunity to compose an e-mail message to accompany the selected video clip. Subsequently, server computer 12 enters an inquiry 178 as to whether the particular user wishes to transmit the e-mail invitation immediately or at a later time. In the former case, the e-mail is composed and transmitted via e-mail transceiver 142 in a step 180. In the latter case, server computer 12 obtains a desired mailing date in a step 182 and schedules the e-mail transmission in a step 184. In a step 186, the particular user receives a confirmation of e-mail transmission. Server computer 12 completes the e-mail routine and proceeds to a subsequent routine in a step 188. If the e-mail transmission(s) is scheduled for a later date, the particular user will receive a first e-mail confirmation as to the scheduled date and subsequently a second e-mail confirmation that the e-mail transmission(s) has been dispatched.

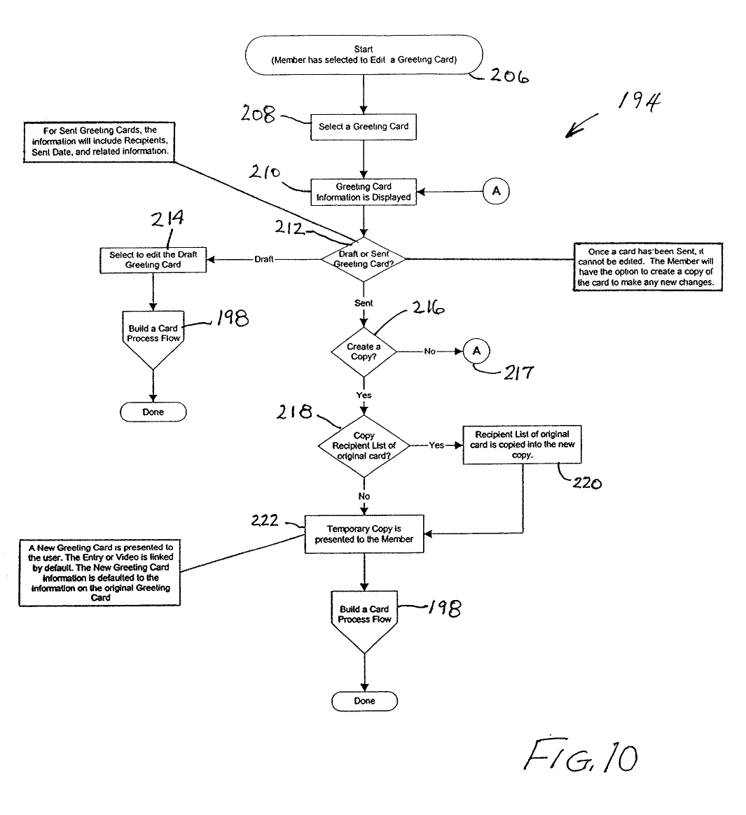

As illustrated in FIG. 9, in an initial step 190 of a video greeting card process flow, server computer 12 recognizes a selection or request from a user computer 16 to process a video greeting card. In a subsequent inquiry 92, computer 12 determines whether the particular user wishes to (a) edit a pre-existing greeting card, (b) delete a greeting card, (c) build a greeting card or (d) generate a mass personalization. Selection of any of the first three choices leads to execution of a respective routine, namely, a routine 194 for editing a greeting card, a routine 196 for deleting a greeting card, or a routine 198 for building a greeting card. Selection of the mass personalization option leads to an inquiry 200 as to whether the particular user has paid for the option. An affirmative outcome to inquiry 200 induces server computer 12 to execute a mass personalization routine 202. A negative outcome to inquiry results in a check 204 of the user's account and an opportunity to pay for the requested option.

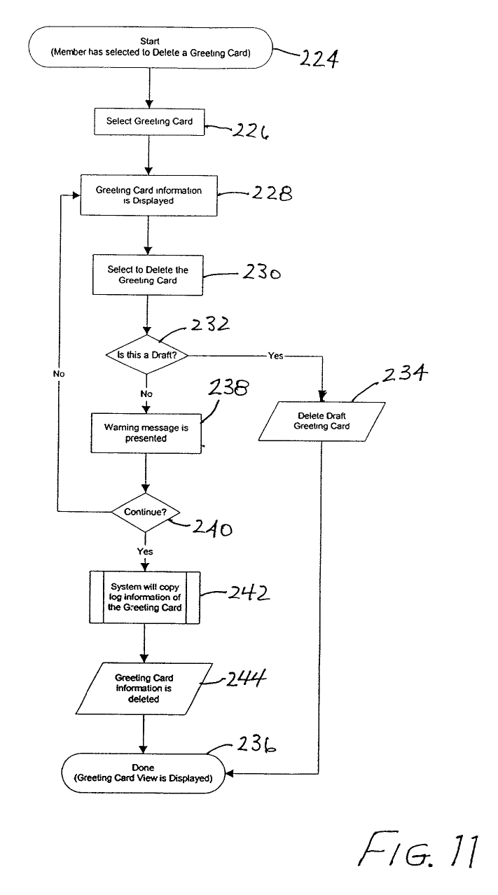

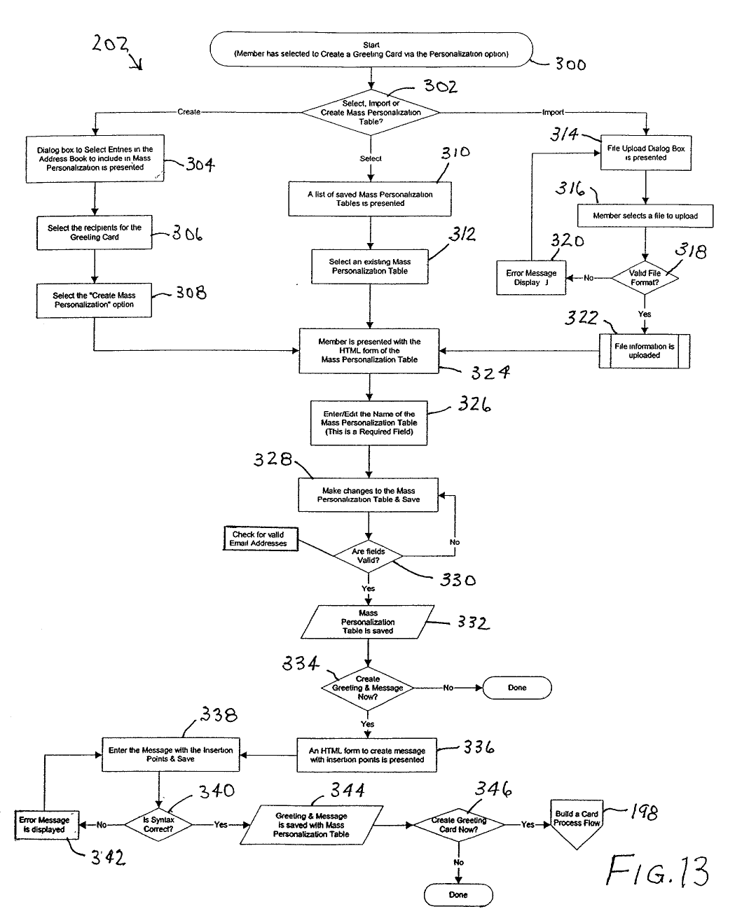

As shown in FIG. 10, card editing routine 194 starts with a step 206 in which server computer 12 recognizes a request to edit a greeting card. In two subsequent steps 208 and 210, Web page generator 44 of server computer 12 provides the respective user with a list of selectable greeting cards including those greeting cards, if any, previously built by the user. At a decision junction 212, server computer 12 inquires as to whether the user has elected to edit a draft (unsent) card or a card that has already been downloaded by one or more recipient computer 18. In the former case, the user selects the particular draft card in a step 214 and enters the card building routine 198 (see FIG. 12). In the latter case, server computer 12 queries at 216 whether the user wishes to create a copy of the sent card. If not, the card editing routine is exited at 217 (not permissible to edit sent cards themselves). If the user consents to creation of a copy, server computer 12 then determines in another query 218 whether the user wishes to also copy the list of recipients of the copied card. If so, the recipient list is copied in a step 220. A temporary card is then presented to the user in a step 222, this temporary card including the same video clip or clips which were parts of the copied greeting card. Subsequently, server computer 12 executes card building routine 198 (FIG. 12).

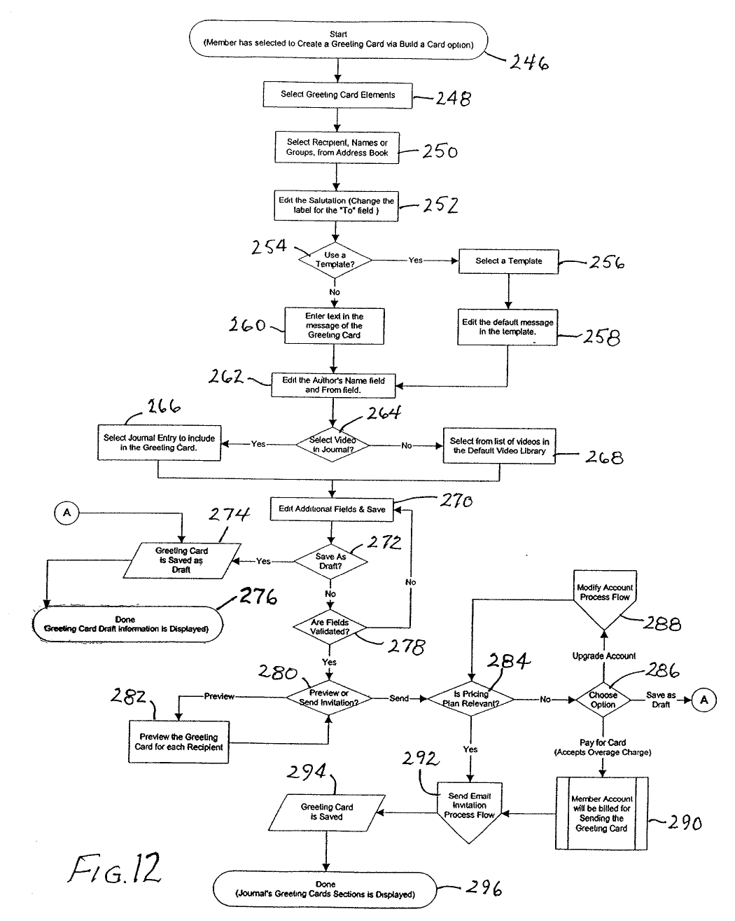

As depicted in FIG. 11, card deletion routine 196 commences with a step 224 in which server computer 12 detects a request to delete a greeting card. A greeting card is selected in a step 226. Server computer 12 transmits information pertinent to the selected greeting card to the particular user in a step 228. The request to delete the selected card is then confirmed in a step 230. If the selected card is a draft card, as determined at a decision junction 232, the card is deleted in a routine 234 and displayed to the user in a final step 236. If server computer 12 determines at decision junctions 232 that the selected card is not a draft, a warning message is issued to the user in a step 238. If the user then wishes to review the decision to delete the selected card, as determined by computer 12 in a check 240, server computer 12 presents the user with an opportunity to review the pertinent information in step 228. If the user desires deletion of the selected card, as determined by computer at check 240, log information pertaining to the selected card is copied in a step 242 and the selected card is deleted in a routine 244.

As illustrated in FIG. 12, card building routine 198 begins with a step 246 in which computer 12 detects the request to create a video greeting card by building a card. In a first step 248, the user selects greeting card elements including the occasion or theme, the background (e.g., a surrounding illustration, pattern, frame, etc.), the illustration or animation, and a font type for any textual material. Possible selections for each of these elements may be stored in illustration and animation database 36. After the selection of the greeting card elements in step 248, the user selects desired recipients in a step 250. Generally, one or more recipients, i.e., individuals or groups, are selected from a previously generated address book. In a following step 252, the user edits the greeting card salutation, i.e., changes the label for the “to” field. Subsequently, server computer 12 inquires (254) whether the user wishes to use a template. If so, a template is selected in a step 256. The template contains a default message (e.g., “Merry Xmas and Happy New Year”) which the user can edit in a step 258. If the user does not wish to use a template, server computer 12 detects the entry by the user of a text in a message field in a step 260 and then records change of the author's name to that of the user in a step 262. Also, the video greeting card will contain a return e-mail which may be edited from a default address in step 262. The default address is an address of the user stored by computer 12 in Wet) page data store 32 (FIG. 3). In a following query 264, computer 12 determines whether the particular user wishes to select (1) a video clip from the user's personal journal or collection of uploaded video clips or (2) a video clip from a set of default clips in a library of the video distribution service. The video clip selection is carried out in a respective step 266 or 268. Additional fields are then edited in a step 270. At that juncture, server computer 12 asks the user in a query 272 whether the user wishes to save the newly created video card as a draft. If so, the card is saved in a step 274 and displayed or transmitted to the user in a step 276. If not, and if the data fields pertaining to the card are complete and acceptable, as verified by server computer 12 at 278, the user is provided at a decision junction 280 with the option of previewing the newly created greeting card. A preview, if requested, is executed in a step 282. If the user decides, on the other hand, to send the newly created greeting card, server computer 12 carries out a check 284 as to whether the user has made proper payment to the video distribution service. If not, the user is provided at 286 with the option of modifying his or her account in a routine 288, saving the newly created greeting card as a draft in step 274, or making a credit card payment in a step 290. Upon proper payment, the newly created greeting card is dispatched in a step 292, the greeting card is saved in a step 294, and verification of transmission is effectuated in a step 296.

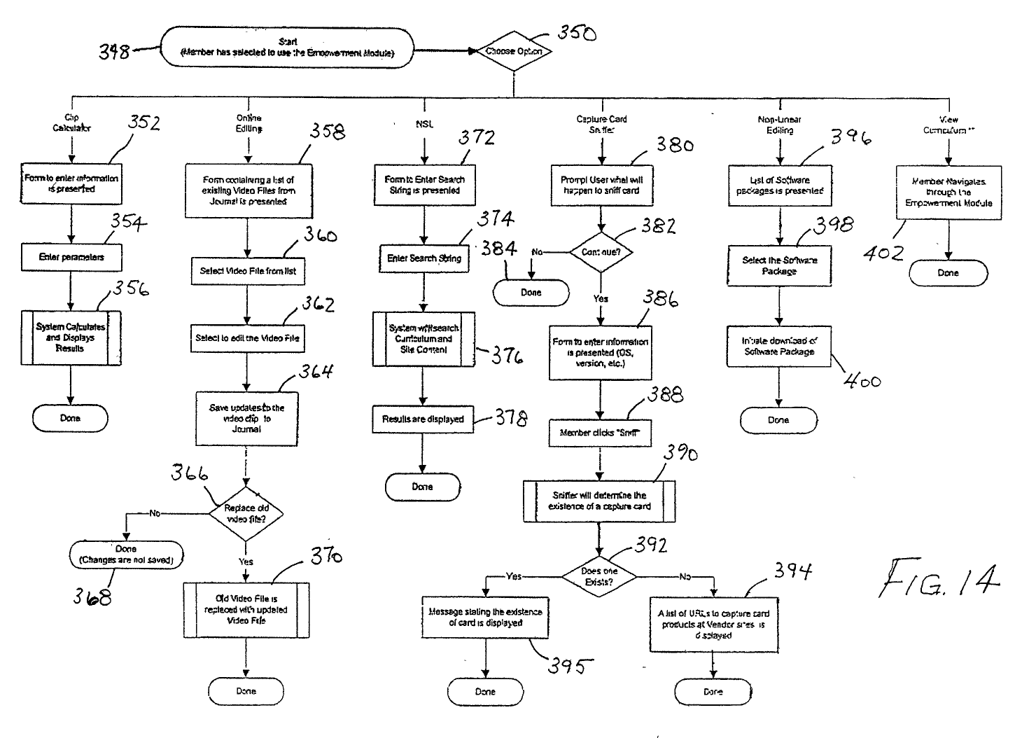

Mass personalization routine 202, shown in FIG. 13, includes an initial step 300 in which server computer 12, and particularly decoder 46 acting in conjunction with Web page generator 44, is informed that a particular user wishes to create a video greeting card via a personalization option. If the user wishes to create a mass personalization table, as discovered by computer 12 in an inquiry 302, the server computer opens a dialog box on the computer monitor of the particular user in a step 304, for enabling the user to select entries in his or her address book for inclusion in the mass personalization table. The user's selections are detected and recorded by server computer 12 in a step 306. Subsequently, the user is prompted in a step 308 to select the option of creating a mass personalization.

If the user wishes to select a mass personalization table, as detected by server computer 12 in inquiry 302, a list of saved mass personalizations is presented to the user in a step 310. The user's selection is detected and recorded in a step 312. If the user wishes to import a mass personalization table, as determined by server computer 12 in inquiry 302, the user is presented in a step 314 with a dialog box indicating potential upload files. The user's selection is detected in a step 316 and checked for format validity at 318. If the file format is unusable, an error message is communicated to the user in a step 320 and the dialog box is again presented (314). If the file format is acceptable, as determined by computer 12 in check 318, the file information is uploaded in a step 322. Computer 12 may provide the user with information on file formats and field ordering.

After the creation, selection or importation of a mass personalization table, server computer 12 presents the particular user in a step 324 with the HTML (Hyper Text Markup Language) form of the mass personalization table. Each mass personalization table includes a plurality of columns each referring to a field for mass personalization, including name, e-mail address, and other data fields. Each table includes a plurality of rows corresponding to respective recipients of a video greeting card selected or created by the particular user. In a subsequent step 326, the user enters or edits the name of the mass personalization table. Then changes are made to the table and saved in a step 328. Possible changes include (a) adding recipients from the user's address book, (b) changing the column order, (c) changing text in the e-mail, name and additional data fields, and (d) selecting, via a check-box, which recipients are to be removed from the listing.

After changes to the mass personalization table made in step 328, server computer 12 undertakes a check 330 as to whether the data fields are complete and valid. For instance, e-mail addresses are checked for validity. If any fields are invalid, computer 12 directs the user back to step 328. In the fields are valid, computer 12 saves the mass personalization table in a step 332 and asks the user in a step 334 whether the user wishes to create a greeting and message now. If not, the mass personalization routine 202 is finished. If so, computer 12 presents the user in a step 336 with an HTML form with insertion points indicated for the entry of a message. The user creates the greeting and the message of the greeting card in step 336. The HTML form includes buttons representing each field in the mass personalization table, except for the e-mail field. Clicking on the button will append the field to the list.

In a step 338 following the message creation step 336, the message entered by the user is saved. The syntax of the message is then checked at 340. In the event of an error, an error message is generated in a step 342. If the message is syntactically proper, the greeting and message are saved together with the mass personalization table in a step 344. The user is then queried at 346 as to whether the user wishes to create a greeting card. An affirmative response works into the card building routine 198 (FIG. 12). It is contemplated that if the user elects to build a card at this juncture, that the user will not be able to add further recipients or to edit the message.

As illustrated in FIG. 14, server computer 12 detects in a step 348 that a particular user has elected to be educated or “empowered” by a tutorial as to how to take video from a regular video camcorder and convert the video to a digital format, how to edit video clips including adding text scenes and music, and how to convert digital footage for e-mail distribution. At a first decision junction 350, server computer 12 determines the specific option selected by the user. If the user selects a clip calculator option, computer 12 transmits a form to the user via the Internet in a step 352 for purposes of prompting or otherwise facilitating the entry of information by the user. Video clip parameters are entered by the user and detected by computer 12 in a step 354. From the uploaded parameters, computer 12 calculates, for example, a clip upload time in a step 356 and transmits the results of the calculation to the respective user computer 16 for display.

If the particular user selects an on-line editing option, as determined by computer 12 at decision junction 350, Web page generator 44 of computer 12 generates a form containing a list of existing video files maintained in database 28 for the particular user, as part of the user's video journal or collection. This form is generated and transmitted to the user in a step 358. In a following step 360, the user selects a video file from the list. This video file is edited then in a step 362. The user indicates in a step 364 that he or she wishes to save the edited video clip. In response, computer 12 queries at 366 whether the user wishes to replace the selected original video clip. If not, the process terminates at 368 without saving the changes. If so, the selected original video clip file is replaced with the updated video clip file in a step 370.

If the particular user selects a search option, as determined by computer 12 at decision junction 350, a form for entering a search string is presented to the user in a step 372. The user enters a desired search in a step 374, whereupon server 12 searches tutorial curriculum and site content in a step 376. Results of the search are displayed in a step 378.

If the particular user selects a capture card “sniffer” option, as determined by computer 12 at decision junction 350, the user is advised in a step 380 as to the function of the “sniffing” process. The user is then asked at 382 whether he or she wishes to continue with the capture card sniff option. A negative reply results in termination 384, while an affirmative reply leads to the transmission of a form in a step 386 for the entry of information as to user's operating system, version, etc. Once the user initiates the sniffing process in a step 388, server computer 12 transmits a sniffer software routine to the respective user computer 16 in a step 390. In a subsequent step 392, computer 12 queries whether a video capture card exists on the user's machine. If not, a list of URLs for existing vendors of various capture card products is provided to the user in a step 394. If so, a message stating the existence of a video capture card on the particular user's computer 16 is presented to the user in a step 395.

If the particular user selects a non-linear editing option, as determined by computer 12 at decision junction 350, computer 12 presents a list of software packages to the user in a step 396. The user subsequently selects a package at 398, which is downloaded in a step 400.

If the particular user selects an option of viewing the tutorial curriculum, as determined by server computer 12 at decision junction 350, the user is enabled in a step 402 to navigate or peruse various curriculum lists, explanations, instructions, FAQs, illustrations, sample scenarios, and glossary of the tutorial.

The empowerment service provided pursuant to the process flow of FIG. 14 provides users with quick access to tools and methods for placing their own video content online instantaneously. The empowerment service, executed, for example, by a dedicated empowerment module (not shown) connected to Web page generator 44 and decoder 46 (FIG. 3), will overcome anxiety and tedium that may be inherent in posting and distributing video to the Internet.

It is contemplated that the various functions modules shown in the drawing figures appended hereto are implemented in the form of generic digital computer circuits as modified by programming to accomplish the intended functions. Other structures within the scope of the instant invention for executing the operations of the various functional modules include hard wired circuits, and various combinations of hard-wired circuits and software-modified generic circuits of one or more general-purpose digital computers. Such combinations may be particular effective inasmuch as some of the illustrated modules, including, but not limited to, the e-mail transceivers, are more suitable for hard-wire (e.g., PCB) implementation than others. It is to be noted, in addition, that at least some of the functional modules of server 12 may be located on different computers. For example, those modules requiring a high processing capacity such as video processor 30 and mixer may be located on separate dedicated computers. Thus, in a preferred embodiment, server computer 12 is to be understood as a single specially programmed digital computer or a group of cooperating computers collectively performing the discussed functions. In the latter case, it is possible for the different computers of the group to be located in different physical locations and to conduct their interlocking functions through the Internet 14.

Moreover, the functional modules of server computer 12 disclosed herein may have their functions distributed throughout a plurality of modules. Some modules may perform several related functions simultaneously.

It is to be noted that background images stored in memory 34 and shown in users' Web pages or journal displays may be dynamic instead of static, with one or more moving elements. Furthermore, the names or identifiers of video clip groupings for the video clip collection of a particular user may themselves move around on the user's Web page or journal display. Thus, if a user selects a baseball field or stadium for a background, images of balls carrying the video clip grouping names or identifiers may move from the location of home plate, where there is displayed a depiction of a swinging batter, towards the viewer who is apparently located in the outfield bleachers. In that case, the baseballs may not only move from one position on the screen to another, but the size of the baseball images may increase, with the names and identifiers becoming more readable as the baseballs become larger.

An advantage of storing video clips in a central location, namely, database 28, facilitates access to any particular video clip via different categories and possibly different Web pages associated with a particular user. Thus, the particular user may have a video clip which is accessible by an authorized viewer (including the particular user) via two or more category names or via two or more events. For example, a video clip of Marsha in her swimming suit dropping a chocolate ice cream cone on herself may be grouped under a Marsha category, a birthday category, and a vacation category. One or more authorized users may be able to download Marsha's video clip by “clicking through” any one of these categories. However, some potential viewers may be authorized to access the Marsha's video clip only through the birthday category, for instance.

An advantageous ancillary service performed by Web site manager 26 is to provide each potential viewer or recipient computer 18 who accesses the Web site with a respective listing of all of the users having uploaded video clips or greeting cards accessible by that potential viewer or recipient computer 18. The listing may merely identify those users, e.g., via name and/or e-mail address, who have authorized the potential viewer or recipient to view one or more video clips in the uploaded clip collections of the identified users. The user entries on the listing may be linked as bookmarks to the users' Web pages, thereby facilitating access of the potential viewer or recipient to the respective downloadable video clips and/or greeting cards.

It is to be noted that the users of a video distribution service as described herein may be corporations and other organizations as well as individual natural persons. Corporations may wish to send video clips and video greeting cards to suppliers and distributors, employees, and/or customers. E-commerce businesses can find the video greeting card to be an effective marketing tool, whether the potential customers are natural persons or other businesses. Accordingly, video clips distributed through the above-described system may have an information content related to corporate or governmental functions. Short instructional video may be distributed to selected groups of employees via the instant video distribution system. In this case, the greeting card aspect of the system may include illustrations and/or textual material which introduces, explains, supplements, or otherwise enhances the informational and emotive content of the video clips. Where the content of the video clips is classified or otherwise necessarily restricted, the video distribution system described herein may be augmented by additional security safeguards and checks to ensure that secret information is distributed only to authorized personnel.

It is to be additionally noted that video clips are only one example of a larger class of content files which may be distributed by server computer 12 through the methods described above. For instance, any multimedia file may be uploaded and centrally stored in database 28, categorized into customized groupings having respective selected names or identifiers, and downloaded to authorized recipient computers 18, where the recipient computers have limited access determined by the uploaders of the multimedia files. As alternatives to the video and video/audio clips described hereinabove, the multimedia files or clips may be purely audio clips, photographs, other kinds of graphic works, 360° panoramic views, textual materials (e.g., poems, essays, instructions), virtual reality segments, etc.

The computer and Internet methods discussed above with reference to video greeting card creation and distribution may similarly be used to create and distribute other kinds of multimedia combinations. Instead of a video clip associated with a graphics or animation, a communication may include an uploaded photograph transmitted in combination with an audio clip, uploaded textual materials transmitted in combination with a selected graphic illustration or animation, textual materials transmitted in combination with an audio clip, etc.

The filtering or screening function described above with reference to module 52 (FIG. 3) is one exemplary function which is useful for virtually any kind of content. In an even broader conception of the applicability of this filtering or screening function (as well as others described herein), the content may be virtually any electronic or digital file, even those which are not intended for human appreciation. Examples of non-multimedia data which may be encapsulated in files selectively distributable to recipient computers pursuant to the filtering or screening methodology discussed above, include financial data, data pertaining to computer network operations, to public or private utilities, government functions, corporate inventory and accounting, etc.

Although the invention has been described in terms of particular embodiments and applications, one of ordinary skill in the art, in light of this teaching, can generate additional embodiments and modifications without departing from the spirit of or exceeding the scope of the claimed invention. For instance, it will be clear to one of ordinary skill in the art that the animations or graphics database may be part of the video database, with predetermined memory locations for graphics images and video clips. Greeting cards may be created en masse by any one user via a mail merge type technique wherein the user's address book is used to generate personalized cards. Accordingly, it is to be understood that the drawings and descriptions herein are proffered by way of example to facilitate comprehension of the invention and should not be construed to limit the scope thereof.

What is claimed is:

1. A video distribution method comprising:
receiving, from each of a plurality of first parties over a computer network, at least one video clip;
storing the received video clips at a central location;
receiving requests from a plurality of second parties over said computer network, said requests each identifying a respective one of said first parties and concomitantly the respective video clip uploaded by said one of said first parties for storage at said central location; and
transmitting, to each one of said second parties over said computer network, at least one video clip uploaded to said central location by a respective one of said first parties identified in the respective request from said one of said second parties.

2. The video distribution method defined in claim 1, further comprising:
receiving from a selected one of said first parties a selection of a graphic illustration; and
in response to a request from a given one of said second parties, transmitting said graphic illustration over said computer network to said given one of said second parties,
the transmitting of video clips to said second parties over said computer network including transmitting the video clip of said selected one of said first parties from said central location to said given one of said second parties over said computer network as a selected video clip so that said selected video clip is viewable by said given one of said second parties on a computer monitor in temporal and spatial juxtaposition to said graphic illustration.

3. The video distribution method defined in claim 2 wherein said graphic illustration is an animation.

4. The video distribution method defined in claim 3 wherein said graphic illustration includes at least one portion which appears as a moving graphic image on said computer monitor, the transmitting of said selected video clip to said given one of said second parties including transmitting said selected video clip so that at least a substantial portion of said selected video clip is viewable by said given one of said second parties on said computer monitor only after substantially all movement of said graphic illustration on said computer monitor has ceased.

5. The video distribution method defined in claim 4 wherein the transmitting of said selected video clip to said given one of said second parties includes transmitting at least said substantial portion of said video clip only after receiving a start-transmission signal from said given one of said second parties.

6. The video distribution method defined in claim 5 wherein the transmitting of said graphic illustration and of said selected video clip include transmitting an initial frame of said selected video clip together with at least a terminal portion of said graphic illustration so that said initial frame of said video clip and said terminal portion appear simultaneously on sa id computer monitor, the transmitting of said graphic illustration and of said selected video clip further including transmitting a selector image displayed on said computer monitor together with said terminal portion of said graphic illustration and said initial frame of said selected video clip, said start-transmission signal resulting from a mouse-click by said given one of said second parties on said selector image.

7. The video distribution method defined in claim 4 wherein the transmitting of said graphic illustration and of said selected video clip include transmitting an initial frame of said selected video clip together with at least a terminal portion of said graphic illustration so that said initial frame of said selected video clip and said terminal portion appear simultaneously on said computer monitor.

8. The video distribution method defined in claim 4 wherein the transmitting of said selected video clip to said given one of said second parties includes transmitting at least a substantial terminal portion of said video clip automatically after transmitting a terminal portion of said animation.

9. The video distribution method defined in claim 4 wherein the transmitting of said graphic illustration and of said selected video clip to said given one of said second parties includes transmitting said graphic illustration and said selected video clip over said computer network using streaming media technology.

10. The video distribution method defined in claim 2, further comprising receiving from said selected one of said first parties an identification of said given one of said second parties prior to the transmitting of said graphic illustration to said given one of second parties.

11. The video distribution method defined in claim 10 wherein the identification of said given one of said second parties includes an e-mail address of said given one of said second parties.

12. The video distribution method defined in claim 2 wherein the transmitting of said graphic illustration to said given one of said second parties includes transmitting said graphic illustration over said computer network using streaming media technology.

13. The video distribution method defined in claim 2 wherein said graphic illustration is one of a plurality of previously created graphic illustrations stored at said central location, further comprising:
transmitting to said selected one of said first parties an identification of said previously created graphic illustrations; and
receiving from said selected one of said first parties a selection of said one of said previously created graphic illustrations prior to the transmitting of said one of said previously stored graphic illustrations to said given one of said second parties.

14. The video distribution method defined in claim 1, further comprising receiving from at least a selected one of said first parties a plurality of identification codes assigned to or associated with respective ones of said second parties.

15. The video distribution method defined in claim 14 wherein the receiving of the video clips includes receiving from said selected one of said first parties a plurality of video clips, further comprising storing at said central location the video clips received from said selected one of said first parties, said identification codes each designating a respective set of the video clips of said selected one of said first parties which are permissibly viewed by the respective one of said second parties via said computer network, the transmitting of the video clips of said selected one of said first parties to said respective ones of said second parties including the transmitting of only those video clips designated as permissibly transmittable to said respective ones of said second parties.

16. The video distribution method defined in claim 14 wherein the video clips uploaded by said selected one of said first parties to said central location are ordered by said selected one of said parties into a plurality of groups, the identification codes from said selected one of said first parties each including a designation of a respective subset of said groups, the transmitting of said video clips of said selected one of said first parties to said ones of said second parties including the transmitting of only those video clips in respective designated subsets of said groups.

17. The video distribution method defined in claim 1 wherein said computer network is the Internet, further comprising providing a Web page for each of said first parties, each of said Web pages including a background image and a plurality of alphanumeric video clip identifiers each designating at least one video clip of the respective one of said first parties.

18. The video distribution method defined in claim 17, further comprising selectively transmitting said video clip identifiers to the second parties so that at least one of said second parties is apprised of only a portion of the video clips received at said central location from a given one of said first parties.

19. The video distribution method defined in claim 17, further comprising
receiving from said one of said first parties a selection of said background image, a selection of said video clip identifiers, and an indication of preferred locations of said video clip identifiers on said background image,
the providing of the respective Web page for said one of said first parties including superimposing the respective selected video clip identifiers on the selected background image at the locations selected by said one of said first parties.

20. The video distribution method defined in claim 1, further comprising:
after receiving from one of said first parties a respective video clip, receiving a video edit instruction from said one of said first parties;
automatically editing said respective video clip in response to said video edit instruction; and
storing the edited video clip in said central location.

21. The video distribution method defined in claim 20, also comprising transmitting to said one of said first parties directions for editing said respective video clip on line.

22. The video distribution method defined in claim 20, also comprising transmitting said edited video clip to said one of said first parties prior to storing said edited video clips at said central location.

23. The video distribution method defined in claim 1, also comprising transmitting a clip calculator to said first parties, said clip calculator including text fields for the entry or inputting of numerical video clip parameters by said first parties, said video clip calculator providing said first parties with a calculated video clip value in response to the entry or inputting of said numerical video clip parameters by said first parties.

24. The video distribution method defined in claim 1 wherein the transmitting of said video clips to said second parties includes transmitting said video clips over said computer network using streaming media technology.

25. A video distribution method comprising:
receiving a video clip from a first party over a computer network;
storing said video clip in a central location;
transmitting a graphic illustration over said computer network from said central location to a second party; and
transmitting said video clip also over said computer network from said central location to said second party so that said video clip is viewable by said second party on a computer monitor in temporal and spatial juxtaposition to said graphic illustration.

26. The video distribution method defined in claim 25 wherein said graphic illustration is an animation.

27. The video distribution method defined in claim 26 wherein said graphic illustration includes at least one portion which appears as a moving graphic image on said computer monitor, the transmitting of said video clip to said second party including transmitting said video clip so that said video clip is viewable by said second party on said computer monitor only after all movement of said graphic illustration has ceased.

28. The video distribution method defined in claim 27 wherein the transmitting of said video clip to said second party includes transmitting at least said substantial portion of said video clip only after receiving a start-transmission signal from said second party.

29. The video distribution method defined in claim 28 wherein the transmitting of said graphic illustration and of said video clip include transmitting an initial frame of said video clip together with at least a terminal portion of said graphic illustration so that said initial frame of said video clip and said terminal portion appear simultaneously on said computer monitor, the transmitting of said graphic illustration and of said video clip further including transmitting a selector image displayed on said computer monitor together with said terminal portion of said graphic illustration and said initial frame of said video clip, said start-transmission signal resulting from a mouse-click by said second party on said selector image.

30. The video distribution method defined in claim 27 wherein the transmitting of said graphic illustration and of said video clip include transmitting an initial frame of said video clip together with at least a terminal portion of said graphic illustration so that said initial frame of said video clip and said terminal portion appear simultaneously on said computer monitor.

31. The video distribution method defined in claim 27 wherein the transmitting of said video clip to said second party includes transmitting at least a substantial terminal portion of said video clip automatically after transmitting a terminal portion of said animation.

32. The video distribution method defined in claim 27 wherein the transmitting of said graphic illustration and of said video clip to said second party includes transmitting said graphic illustration and said video clip over said computer network using streaming media technology.

33. The video distribution method defined in claim 25, further comprising:
after receiving said video clip, receiving a video edit instruction from said first party; and
automatically editing said video clip in response to said video edit instruction,
the storing and the transmitting of said video clip being executed after editing of said video clip.

34. The video distribution method defined in claim 25, further comprising receiving from said first party an identification of said second party prior to the transmitting of said graphic illustration and said video clip to said second party.

35. The video distribution method defined in claim 34 wherein the identification of said second party includes an e-mail address of said second party.

36. The video distribution method defined in claim 25 wherein the transmitting of said video clips to said second parties includes transmitting said video clips over said computer network using streaming media technology.

37. The video distribution method defined in claim 25 wherein said graphic illustration is one of a plurality of previously created graphic illustrations stored at said central location, further comprising:
transmitting to said first party an identification of said previously created graphic illustrations; and
receiving from said first party a selection said one of said previously created graphic illustrations prior to the transmitting of said one of said previously stored graphic illustrations to said second party.

38. A video distribution system comprising:
a server computer linked to a computer network for receiving, from each of a plurality of first parties over said computer network, at least one video clip and for receiving requests from a plurality of second parties over said computer network, said requests each identifying a respective one of said first parties and concomitantly the respective video clip uploaded by said one of said first parties; and
a video database operatively connected to said server computer for storing the received video clips at a central location,
said server computer including a transmission module operatively linked to said database and to said computer network for transmitting, to each one of said second parties over said computer network, at least one video clip stored in said database by a respective one of said first parties identified in the respective request from said one of said second parties.

39. The video distribution system defined in claim 38 wherein said server computer further includes:
an additional database storing a multiplicity of graphic illustrations; and
a video greeting card unit operatively linked to said video database, said additional database and said computer network for selecting a video clip from said video database and a graphic illustration from said additional database in response to instructions received over said computer network and for transmitting the selected graphic illustration and the selected video clip over said computer network to an addressee identified in said instructions.

40. The video distribution system defined in claim 39 wherein said video greeting card unit includes a timing module for ensuring that said selected video clip is viewable by said addressee on a computer monitor in temporal and spatial juxtaposition to said selected graphic illustration.

41. The video distribution system defined in claim 40 wherein said graphic illustration is an animation.

42. The video distribution system defined in claim 41 wherein said graphic illustration includes at least one portion which appears as a moving graphic image on said computer monitor, said timing module including means for ensuring that at least a substantial portion of said selected video clip is viewable by said addressee on said computer monitor only after substantially all movement of said graphic illustration on said computer monitor has ceased.

43. The video distribution system defined in claim 42 wherein said timing module includes a delay component operatively connected to said video database and said computer network for transmitting at least said substantial portion of said video clip to said addressee only after receiving a start-transmission signal from said addressee.

44. The video distribution system defined in claim 43 wherein said timing module additionally includes a freeze-frame component operatively linked to said video database and said computer network for transmitting only an initial frame of said selected video clip together with at least a terminal portion of said graphic illustration to said addressee via said computer network so that said initial frame of said video clip and said terminal portion appear simultaneously on said computer monitor, said video greeting card unit further including an image control module for transmitting a selector image displayed on said computer monitor together with said terminal portion of said graphic illustration and said initial frame of said selected video clip, said start-transmission signal resulting from a mouse-click by said addressee on said selector image.

45. The video distribution system defined in claim 42 wherein said timing module includes a freeze-frame component operatively linked to said video database and said computer network for transmitting only an initial frame of said selected video clip with at least a terminal portion of said graphic illustration to said addressee so that said initial frame of said selected video clip and said terminal portion appear simultaneously on said computer monitor.

46. The video distribution system defined in claim 42 wherein said timing module includes a trigger module transmitting at least a substantial terminal portion of said video clip automatically after transmitting a terminal portion of said animation.

47. The video distribution system defined in claim 42 wherein said video greeting card unit is connected to streaming media transmission componentry for transmitting said graphic illustration and said selected video clip to said addressee.

48. The video distribution system defined in claim 40 wherein said server computer further includes addressing circuitry for identifying an e-mail address of said addressee from said instructions prior to the transmitting of said graphic illustration to said addressee.

49. The video distribution system defined in claim 39 wherein said video greeting card unit is connected to streaming media transmission componentry for transmitting said graphic illustration and said selected video clip to said addressee.

50. The video distribution system defined in claim 39 wherein said instructions are received from a particular one of said first parties over said computer network, said graphic illustration being one of a plurality of previously created graphic illustrations stored at said central location, said server computer further including:
a graphics identification module transmitting to said particular one of said first parties an identification of said previously created graphic illustrations; and
a graphics selection module receiving from said particular one of said first parties a selection said one of said previously created graphic illustrations prior to the transmitting of said one of said previously stored graphic illustrations to said addressee.

51. The video distribution system defined in claim 38 wherein said server computer further includes a decoder operatively connected to said computer network for receiving and recognizing from at least a selected one of said first parties a plurality of identification codes assigned to or associated with respective ones of said second parties.

52. The video distribution system defined in claim 51 wherein said server computer includes a categorizing module operatively connected to said computer network and said video database for ordering in groups in said video database a plurality of video clips received from said selected one of said first parties, said groups being defined by said selected one of said first parties, said identification codes each designating a respective one of said groups of the video clips of said selected one of said first parties which are permissibly viewed by the respective one of said second parties via said computer network, said server computer including a filter or screening component so that the transmitting of the video clips of said selected one of said first parties to said respective ones of said second parties includes the transmitting of only those video clips designated by said selected one of said first parties as permissibly transmittable to said respective ones of said second parties.

53. The video distribution system defined in claim 51 wherein said server computer includes a categorizing module operatively connected to said computer network and said video database for ordering in groups in said video database a plurality of video clips received from said selected one of said first parties, the identification codes from said selected one of said first parties each including a designation of a respective set of said groups, said server computer including a filter or screening component so that the transmitting of the video clips of said selected one of said first parties to said respective ones of said second parties includes the transmitting of only those video clips in respective designated sets of said groups.

54. The video distribution system defined in claim 38 wherein said computer network is the Internet, said server computer further including a Web-site management module providing a Web page for each of said first parties wherein each said Web page includes a background image and a plurality of alphanumeric video clip identifiers each designating at least one video clip of the respective one of said first parties.

55. The video distribution system defined in claim 54 wherein said server computer further includes a filtering or screening module for inducing a selective transmission of said video clip identifiers to the second parties so that at least one of said second parties is apprised of only a portion of the video clips received at said central location from a given one of said first parties.

56. The video distribution system defined in claim 54 wherein said Web-site management module includes:
decoding componentry receiving from said one of said first parties a selection of said background image, a selection of said video clip identifiers, and an indication of preferred locations of said video clip identifiers on said background image; and
superposition componentry controlling the appearance of the Web-page of said one of said first parties so that the respective selected video clip identifiers are superimposed on the selected background image at the locations selected by said one of said first parties.

57. The video distribution system defined in claim 38 wherein said server computer further includes a video edit module operatively connected to said computer network and to said video database for automatically editing a video clip in response to a video edit instruction received from one of said first parties.

58. The video distribution system defined in claim 57 wherein said video edit module is operatively connected to said transmission module for transmitting said edited video clip to said one of said first parties prior to storing said edited video clips at said central location.

59.The video distribution system defined in claim 38 wherein said server computer includes streaming media transmission componentry for transmitting said video clips to said second parties.

60. A video distribution system comprising:
a server computer operatively coupled to a computer network for receiving a video clip from a first party over a computer network;
a video database operatively linked to said server computer for storing said video clip and a plurality of graphic illustrations;
said server computer including a video greeting card unit operatively linked to said video database and said computer network for transmitting a selected one of said graphic illustrations over said computer network from said central location to a second party and for transmitting said video clip also over said computer network to said second party so that said video clip is viewable by said second party on a computer monitor in temporal and spatial juxtaposition to said graphic illustration.

61. The video distribution system defined in claim 60 wherein said graphic illustration is an animation.

62. The video distribution system defined in claim 61 wherein said video greeting card unit includes a timing module for ensuring that said video clip is viewable by said second party on a computer monitor in temporal and spatial juxtaposition to said selected one of said graphic illustrations, said selected one of said graphic illustrations including at least one portion which appears as a moving graphic image on said computer monitor, said timing module including means for ensuring that at least a substantial portion of said video clip is viewable by said second party on said computer monitor only after substantially all movement of said graphic illustration on said computer monitor has ceased.

63. The video distribution system defined in claim 62 wherein said timing module includes a delay component operatively connected to said video database and said computer network for transmitting at least said substantial portion of said video clip to said second party only after receiving a start-transmission signal from said second party.

64. The video distribution system defined in claim 63 wherein said timing module additionally includes a freeze-frame component operatively linked to said video database and said computer network for transmitting only an initial frame of said video clip together with at least a terminal portion of said selected one of said graphic illustrations to said second party via said computer network so that said initial frame of said video clip and said terminal portion appear simultaneously on said computer monitor, said video greeting card unit further including an image control module for transmitting a selector image displayed on said computer monitor together with said terminal portion of said graphic illustration and said initial frame of said selected video clip, said start-transmission signal resulting from a mouse-click by said second party on said selector image.

65. The video distribution system defined in claim 62 wherein said timing module includes a freeze-frame component operatively linked to said video database and said computer network for transmitting only an initial frame of said video clip with at least a terminal portion of said selected one of said graphic illustrations to said second party so that said initial frame of said video clip and said terminal portion appear simultaneously on said computer monitor.

66. The video distribution system defined in claim 62 wherein said timing module includes a trigger module transmitting at least a substantial terminal portion of said video clip automatically after transmitting a terminal portion of said animation.

67. The video distribution system defined in claim 60 wherein said server computer further includes a video edit module operatively connected to said computer network and to said video database for automatically editing said video clip in response to a video edit instruction received from said first party and for storing the edited video clip in said video database.

68. The video distribution system defined in claim 60 wherein said video greeting card unit is connected to streaming media transmission componentry for transmitting said selected one of said graphic illustrations and said video clip to said second party.
